(19) United States
(12) Patent Application Publication
(10) Pub. No.: US 2009/0286060 A1
(43) Pub. Date: Nov. 19, 2009

(54) Degradable polymer article

(76) Inventors: Massimiliano Sala, Castelnuovo Rangone (IT); Stefano Gardi, Bologna (IT); Gunther Schlingloff, Riehen (CH)

Correspondence Address: JoAnn Villamizar;Ciba Corporation/Patent Department, 540 White Plains Road, P.O. Box 2005, Tarrytown, NY, 10591, US

(21) Appl. No.: 11/991,448

(22) PCT Filed: Aug. 28, 2006
(86) PCT No.: PCT/EP2006/065720

§ 371 Date: Mar. 4, 2008

(30) Foreign Application Priority Data
Sep. 7, 2005 (EP) 05108201.4

(51) Int. Cl. B32B 27/32; C08K 5/3447; C08K 5/3495

(52) U.S. Cl. 428/220; 523/124; 523/125; 523/126

(57) ABSTRACT

A polymer article having accelerated degradability triggered by light and/or heat and/or humidity and made of a composition containing (A) a natural and/or a synthetic polymer and (B) a degradation accelerator of the formula (I), wherein n is 1, 2 or 4; X is >C=0, >S(O)₂ or >C(X₁)(X₂); X₁ and X₂ independently of one another are hydrogen, C₁-C₂₀alkyl, C₃-C₁₂cycloalkyl unsubstituted or substituted by 1, 2 or 3 C₁-C₄alkyl; or phenyl unsubstituted or substituted by 1, 2 or 3 C₁-C₄alkyl; Y is C₁-C₃₀alkyl, C₂-C₃₀alkenyl, C₃-C₁₂cycloalkyl unsubstituted or substituted by 1, 2 or 3 C₁C₄alkyl; C₅-C₁₂cycloalkenyl unsubstituted or substituted by 1, 2 or 3 C₁C₄alkyl; a bicyclic or tricyclic hydrocarbyl having 6 to 10 carbon atoms, C₇-C₄phenylalkyl unsubstituted or substituted on the phenyl by 1, 2 or 3 C₁-C₄alkyl; diphenylmethyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, C₁-C₃₀sulfonyl, —Si(Y₁)₃ or —Si(OY₂)₃; Y₀, Y₁ and Y₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and Z is an organic radical; with the provisos that (1) when Y is C₁-C₃₀alkyl, C₂-C₃₀alkenyl or C₁-C₃₀sulfonyl, component (A) is a polyolefin homo- or copolymer or a blend of a polyolefin homo- or copolymer with another synthetic polymer; and (2) when n is 2 or 4 and, at the same time, component (A) is a polyolefin homo- or copolymer or a blend of a polyolefin homo- or copolymer with another synthetic polymer, Y is additionally hydrogen.

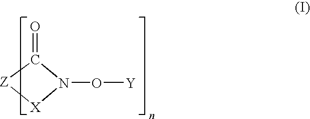

The present invention relates to a polymer article having accelerated degradability triggered by light and/or heat and/or humidity and made of a composition containing a natural and/or a synthetic polymer and a particular degradation accelerator.

Plastic articles find widespread applications in everyday life because of their durability in use and cost effectiveness. With proper stabilization, most commercial plastics are made to last for years.

In recent years however, environmental concern has lead to the development of so called biodegradable materials, of diverse origin and nature, which will maintain their function and integrity during service life, but disintegrate after use into carbon dioxide and water, either triggered by chemical means or by microorganisms. One problem however is establishing a suitable equilibrium between biodegradability and integrity during service life.

The use of N-hydroxyphthalimide derivatives as oxygen absorbers in packaging materials is described in EP-A-1,650,265.

Phthalimide derivatives as acid producing agents for obtaining chemically amplified resist compositions are described in U.S. Pat. No. 6,767,687 and US-A-2005/0038261.

N-tosyloxyphthalimide as acid generator in a film device to visualize UV irradiation is described by K. Takato et al. in Journal of Photochemistry and Photobiology A: Chemistry 163 (2004) 271-276.

Bis allyloxyimides as co-reactants in thermosetting matrix resins are described in U.S. Pat. No. 5,760,165.

Degradable plastic compositions are described in e.g. U.S. Pat. No. 4,042,765, WO-A-92/11,298, U.S. Pat. No. 4,495,311 and U.S. Pat. No. 3,993,634.

The preparation of cyclic N-hydroxydicarboximide derivatives is described in e.g. U.S. Pat. No. 6,316,639.

The present invention relates in particular to

a polymer article having accelerated degradability triggered by light and/or heat and/or humidity and made of a composition containing
(A) a natural and/or a synthetic polymer and
(B) a degradation accelerator of the formula (I)

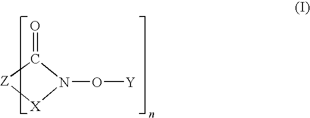

wherein
n is 1, 2 or 4;

### X is >C═O, >S(O)₂ or >C(X₁)(X₂);

X₁ and X₂ independently of one another are hydrogen, C₁-C₂₀alkyl, C₃-C₁₂cycloalkyl unsubstituted or substituted by 1, 2 or 3 C₁-C₄alkyl; or phenyl unsubstituted or substituted by 1, 2 or 3 C₁-C₄alkyl;
Y is C₁-C₃₀alkyl, C₂-C₃₀alkenyl, C₃-C₁₂cycloalkyl unsubstituted or substituted by 1, 2 or 3 C₁-C₄alkyl; C₅-C₁₂cycloalkenyl unsubstituted or substituted by 1, 2 or 3 C₁-C₄alkyl; a bicyclic or tricyclic hydrocarbyl having 6 to 10 carbon atoms, C₇-C₉phenylalkyl unsubstituted or substituted on the phenyl by 1, 2 or 3 C₁-C₄alkyl; diphenylmethyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, C₁-C₃₀sulfonyl, —Si(Y₁)₃ or —Si(OY₂)₃;
Y₀, Y₁ and Y₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
and
Z is an organic radical;
with the provisos that
(1) when Y is C₁-C₃₀alkyl, C₂-C₃₀alkenyl or C₁-C₃₀sulfonyl, component (A) is a polyolefin homo- or copolymer or a blend of a polyolefin homo- or copolymer with another synthetic polymer; and
(2) when n is 2 or 4 and, at the same time, component (A) is a polyolefin homo- or copolymer or a blend of a polyolefin homo- or copolymer with another synthetic polymer, Y is additionally hydrogen.

The radical Y is preferably different from hydrogen.

According to one of the preferred embodiments, Z is an organic radical containing one or more aromatic groups.

When n is 1, Z is in particular a group of the formula (I-a), (I-b), (I-c), (I-d), (I-e), (I-f), (I-g), (I-h), (I-i), (I-j), (I-k), (I-l), (I-m) or (I-n)

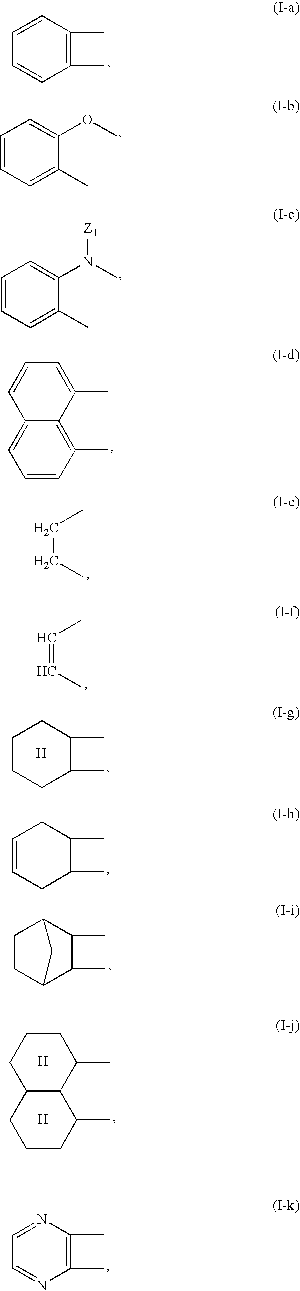

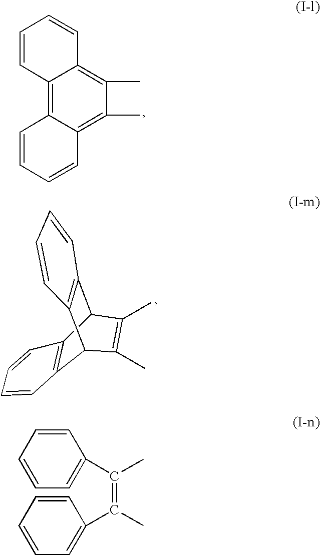

the aromatic rings of the formulae (I-a) to (I-d) and (I-k) to (I-n) and the residues of the formulae (I-e) to (I-j) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₁₀₀, Z₁₀₁, Z₁₀₂ and Z₁ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and
when n is 2, Z is in particular a group of the formula (II-a), (II-b), (II-c) or (II-d),

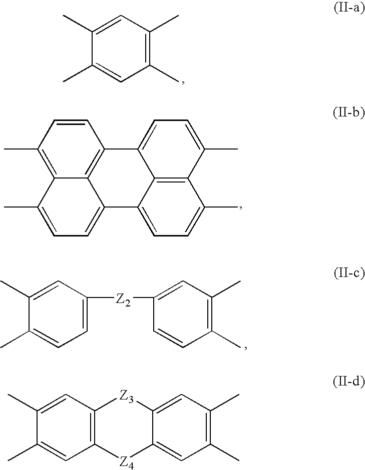

the aromatic rings of the formulae (II-a) to (II-c) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₂ is >C═O, —O—, —S—, >N—R₁, >S═O or —S(O)₂—, C₃-C₃₀diacyl, C₃-C₃₀di(acyloxy), C₃-C₄₅dicarboxylate, C₃-C₄₅di(carboxamide), diamine or diamide;
Z₃ and Z₄ independently of one another are >C═O, —O—, —S—, >N—R₂, >S═O or —S(O)₂—;
R₁ and R₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
when n is 4, Z is a group of the formula (III-a)

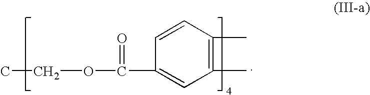

Examples of alkyl having up to 30 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl and eicosyl. In general, C₁-C₂₀alkyl, in particular C₄-C₂₀alkyl or C₆-C₂₀alkyl is preferred. Z₁, R₁ and R₂ independently of one another are e.g. C₁-C₄alkyl.

Examples of C₁-C₃₀alkyloxy are methoxy, ethoxy, propoxy, isopropoxy, n-butoxy, sec-butoxy, isobutoxy, tert-butoxy, 2-ethylbutoxy, n-pentyloxy, isopentyloxy, 1-methylpentyloxy, 1,3-dimethylbutyloxy, n-hexyloxy, 1-methylhexyloxy, n-heptyloxy, isoheptyloxy, 1,1,3,3-tetramethylbutyloxy, 1-methylheptyloxy, 3-methylheptyloxy, n-octyloxy, 2-ethylhexyloxy, 1,1,3-trimethylhexyloxy, 1,1,3,3-tetramethylpentyloxy, nonyloxy, decyloxy, undecyloxy, 1-methylundecyloxy, dodecyloxy, 1,1,3,3,5,5-hexamethylhexyloxy, tridecyloxy, tetradecyloxy, pentadecyloxy, hexadecyloxy, heptadecyloxy, octadecyloxy and eicosyloxy. C₁-C₂₀alkyloxy is preferred.

Examples of alkenyl having up to 30 carbon atoms are allyl, 2-methallyl, butenyl, pentenyl, hexenyl and oleyl. The carbon atom in position 1 is preferably saturated. C₃-C₁₈alkenyl is particularly preferred.

Examples of C₂-C₃₀alkenyloxy are allyloxy, 2-methallyloxy, butenyloxy, pentenyloxy, hexenyloxy and oleyloxy. C₃-C₁₈alkenyloxy is particularly preferred.

Examples of C₃-C₁₂cycloalkyl unsubstituted or substituted by 1, 2 or 3 C₁-C₄alkyl are cyclopentyl, cyclohexyl, cycloheptyl, cyclooctyl, cyclododecyl and 2-methylcyclohexyl. C₅-C₆cycloalkyl unsubstituted or substituted by methyl are preferred.

Examples of C₃-C₁₂cycloalkyloxy unsubstituted or substituted by 1, 2 or 3 C₁-C₄alkyl are cyclopentyloxy, cyclohexyloxy, cycloheptyloxy, cyclooctyloxy, cyclododecyloxy and 2-methylcyclohexyloxy. C₅-C₆cycloalkyloxy unsubstituted or substituted by methyl are preferred

Examples of C₅-C₁₂cycloalkenyl unsubstituted or substituted by 1, 2 or 3 C₁-C₄alkyl are cyclohexenyl and methylcyclohexenyl.

Examples of C₆-C₁₈aryl are phenyl and naphthyl which may optionally be substituted. Unsubstituted or substituted phenyl is preferred.

Examples of phenyl substituted by 1, 2 or 3 C₁-C₄alkyl are 4-methylphenyl, 2-ethylphenyl, 4-ethylphenyl, 4-isopropylphenyl, 4-tert-butylphenyl, 4-sec-butylphenyl, 4-isobutylphenyl, 3,5-dimethylphenyl, 3,4-dimethylphenyl, 2,4-dimethylphenyl, 2,6-diethylphenyl, 2-ethyl-6-methylphenyl and 2,6-diisopropylphenyl.

Examples of C₆-C₁₈ aryloxy are phenyloxy and naphthyloxy which may optionally be substituted. Phenyloxy unsubstituted or substituted by 1, 2 or 3 C₁-C₄alkyl is preferred. 4-Methylphenyloxy, 2-ethylphenyloxy, 4-ethylphenyloxy, 4-isopropylphenyloxy, 4-tertbutylphenyloxy, 4-sec-butylphenyloxy, 4-isobutylphenyloxy, 3,5-dimethylphenyloxy, 3,4-dimethylphenyloxy, 2,4-dimethylphenyloxy, 2,6-diethylphenyloxy, 2-ethyl-6-methylphenyloxy and 2,6-diisopropylphenyloxy are particularly preferred.

An example of diphenylmethyl substituted on the phenyl by 1, 2 or 3 C₁-C₄alkyl is di[methylphenyl]methyl.

An examples of triphenylmethyl substituted on the phenyl by 1, 2 or 3 C₁-C₄alkyl is tris[methylphenyl]methyl.

Examples of C₇-C₉phenylalkyl unsubstituted or substituted on the phenyl by 1, 2 or 3 C₁-C₄alkyl are benzyl, 2-phenylethyl, methylbenzyl, dimethylbenzyl, trimethylbenzyl and tert-butylbenzyl.

Examples of acyl having up to 30 carbon atoms are C₂-C₃₀alkanoyl, C₃-C₃₀alkenoyl and unsubstituted or substituted benzoyl. C₂-C₂₀alkanoyl, C₃-C₂₀alkenoyl and substituted benzoyl are preferred. Acetyl, propionyl, butyryl, pentanoyl, hexanoyl, octanoyl, benzoyl, acryloyl and crotonoyl are more specific examples. A group of the formula

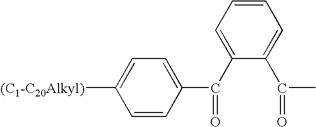

as well as C₂-C₂₀alkanoyl and C₃-C₂₀alkenoyl are particularly preferred.

A preferred example of C₁-C₃₀sulfonyl is the group

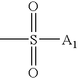

wherein A₁ is C₁-C₃₀alkyl, C₃-C₃₀alkenyl, C₃-C₁₂cycloalkyl which is unsubstituted or substituted by 1, 2 or 3 C₁-C₄alkyl; phenyl unsubstituted or substituted by 1, 2 or 3 C₁-C₂₀alkyl; or C₇-C₉phenylalkyl which is unsubstituted or substituted on the phenyl by 1, 2 or 3 C₁-C₄alkyl. A particularly preferred radical is

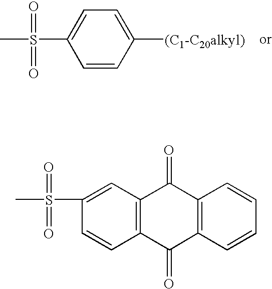

which may optionally be substituted. Further examples of sulfonyl are

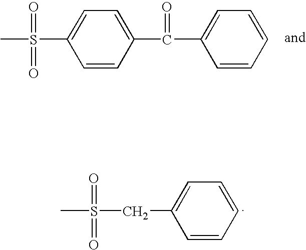

Examples of a bicyclic or tricyclic hydrocarbyl having 6 to 10 carbon atoms are

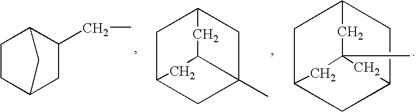

A preferred example of C₂-C₃₀carboxylate is the group

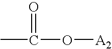

wherein A₂ is C₁-C₂₉alkyl, C₃-C₁₈alkenyl, C₃-C₁₂cycloalkyl which is unsubstituted or substituted by 1, 2 or 3 C₁-C₄alkyl; phenyl unsubstituted or substituted by 1, 2 or 3 C₁-C₄alkyl; or C₇-C₉phenylalkyl which is unsubstituted or substituted on the phenyl by 1, 2 or 3 C₁-C₄alkyl.

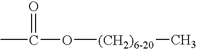

is particularly preferred.

A preferred example of C₂-C₃₀carboxamide is the group

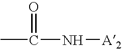

wherein A′₂ has one of the definitions of A₂.

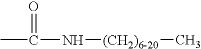

is particularly preferred.

Examples of C₂-C₃₀acyloxy are C₂-C₂₀alkanoyloxy, C₃-C₂₀alkenoyloxy and substituted benzoyloxy are preferred. Acetyloxy, propionyloxy, butyryloxy, pentanoyloxy, hexanoyloxy, octanoyloxy, benzoyloxy, acryloyloxy and crotonoyloxy are more specific examples. C₂-C₂₀alkanoyloxy, C₃-C₂₀alkenoyloxy and benzoyloxy are particularly preferred.

A preferred example of C₃-C₃₀diacyl is the group

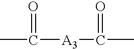

wherein A₃ is C₂-C₂₀alkylene, C₂-C₂₀alkylene interrupted by oxygen, sulphur or >N—R₃ with R₃ having one of the meanings of R₁; C₂-C₁₂alkenylene, C₂-C₁₂alkynylene, C₅-C₁₂cycloalkylene, C₅-C₁₂cycloalkylene-(C₁-C₄alkylene)-C₅-C₁₂cycloalkylene, C₁-C₄alkylene-(C₅-C₁₂cycloalkylene)-C₁-C₄alkylene, phenylene, phenylene-(C₁-C₄alkylene)-phenylene or C₁-C₄alkylene-phenylene-C₁-C₄alkylene.

A preferred example of C₃-C₃₀di(acyloxy) is the group

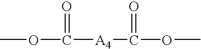

wherein A₄ has one of the definitions of A₃.

A preferred example of C₃-C₄₅dicarboxylate is the group

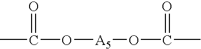

wherein A₅ has one of the definitions of A₃. A further preferred example is

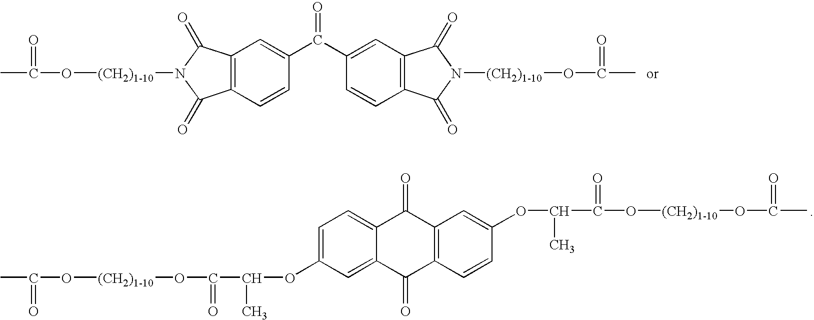

A preferred example of C₃-C₄₅di(carboxamide) is the group

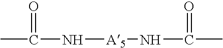

wherein A′₅ has one of the definitions of A₃.

A preferred example of diamine is the group

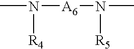

wherein R₄ and R₅ independently of one another have one of the meanings of R₁ and A₆ has one of the meanings of A₃.

A preferred example of diamide is the group

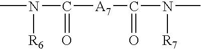

wherein R₆ and R₇ independently of one another have one of the definitions of R₁ and A₇ has one of the definitions of A₃.

Examples of alkylene having up to 20 carbon atoms are ethylene, propylene, trimethylene, tetramethylene, pentamethylene, hexamethylene, octamethylene, decamethylene and dodecamethylene.

Examples of alkylene having up to 20 carbon atoms and being interrupted by oxygen, sulphur or >N—R₃ are 3-oxapentane-1,5-diyl, 4-oxaheptane-1,7-diyl, 3,6-dioxaoctane-1,8-diyl, 4,7-dioxadecane-1,10-diyl, 4,9-dioxadodecane-1,12-diyl, 3,6,9-trioxaundecane-1,1′-diyl, 4,7,10-trioxamidecane-1,13-diyl, 3-thiapentane-1,5-diyl, 4-thiaheptane-1,7-diyl, 3,6-dithiaoctane-1,8-diyl, 4,7-dithiadecane-1,10-diyl, 4,9-dithiadodecane-1,12-diyl, 3,6,9-trithiaundecane-1,11-diyl, 4,7,10-trithiamidecane-1,13-diyl and —CH₂CH₂CH₂—N(R₃)—CH₂CH₂—N(R₃)—CH₂CH₂CH₂—, in particular —CH₂CH₂CH₂—N(CH₃)—CH₂CH₂—N(CH₃)—CH₂CH₂CH₂—.

An example of C₂-C₁₂alkenylene is 3-hexenylene.

An example of C₂-C₁₂alkynylene is CH₂CH₂—C≡C—CH₂CH₂. C₆-C₁₂alkynylene is preferred.

An example of C₅-C₁₂cycloalkylene is cyclohexylene.

Examples of C₅-C₁₂cycloalkylene-(C₁-C₄alkylene)-C₅-C₁₂cycloalkylene are methylenedicyclohexylene and isopropylidenedicyclohexylene.

An example of C₁-C₄alkylene-(C₅-C₁₂cycloalkylene)-C₁-C₄alkylene is cyclohexylenedimethylene.

An example of phenylene-(C₁-C₄alkylene)-phenylene is methylenediphenylene.

An example of C₁-C₄alkylene-phenylene-C₁-C₄alkylene is phenylenedimethylene.

Preferred examples of the radical X are >C═O, >S(O)₂, >CH₂, >C(CH₃)₂ and >C(phenyl)₂.

X as >C═O is particularly preferred.

n is preferably 1 or 2,

For n=1, Z is preferably a group of the formula (I-a) or (I-d), and for n=2, Z is preferably a group of the formula (II-a) or (II-c).

A preferred example of the group (I-a) is the residue of the formula (I-a-1).

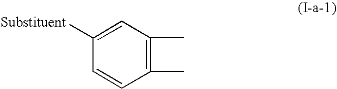

### Further Preferred Embodiments of the Present Invention are:

1) A polymer article as defined above, wherein Y is hydrogen and
when n is 1, Z is a group of the formula (I-b), (I-c), (I-d), (I-j, (I-k), (I-l), (I-n) or (I-m), and
when n is 2, Z is a group of the formula (II-a), (II-b), (II-c) or (II-d).
2) A polymer article as defined above, wherein
when n is 1, Z is a group of the formula (I-a) unsubstituted or substituted by C₂-C₃₀carboxylate or C₂-C₃₀carboxamide; and
when n is 2, Z is a group of the formula (II-a) or (II-c).
3) A polymer article as defined above, wherein
when n is 1, Z is a group of the formula (I-a) substituted on the aromatic ring by —COOH, an C₈-C₂₂alkylcarboxylate of the formula

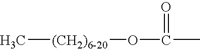

or an C₈-C₂₂alkylcarboxamide of the formula

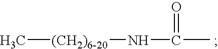

or a group of the formula (I-d); and
when n is 2, Z is a group of the formula (II-c) wherein Z₂ is a dicarboxylate of the formula

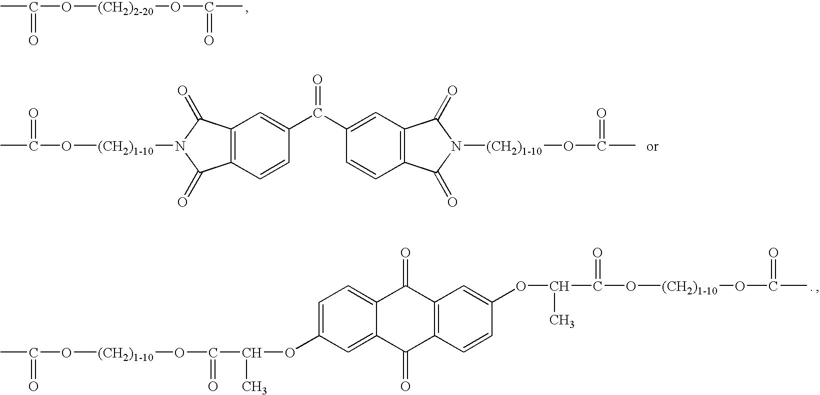

or a di(carboxamide) of the formula

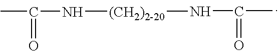

4) A polymer article as defined above, wherein Y is C₁-C₃₀alkyl, C₇-C₉phenylalkyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, C₁-C₃₀sulfonyl or —Si(Y₁)₃; and
Y₀ and Y₁ are C₁-C₁₈alkyl or phenyl which is unsubstituted or substituted by 1, 2 or 3 C₁-C₄alkyl.
5) A polymer article as defined above, wherein n is 1 or 2, and
when n is 1, Z is a group of the formula (I-a) or (I-d), the aromatic rings of the formula (I-a) or (I-d) are optionally substituted by C₂-C₃₀carboxylate or —COOH;
when n is 2, Z is a group of the formula (II-a) or (II-c), and
Z₂ is >C═O or C₃-C₄₅dicarboxylate.
6) A polymer article as defined above, wherein
n is 1 or 2;
Y is C₁-C₃₀alkyl, triphenylmethyl, benzyl, C₂-C₃₀alkanoyl,

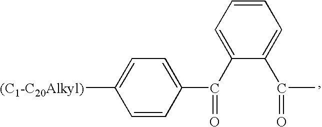

—COOY₀ with Y₀ being C₁-C₁₈alkyl;
tosyl or tert-butyldiphenylsilanyl, and when n is 2, Y is additionally hydrogen;
when n is 1, Z is a group of the formula

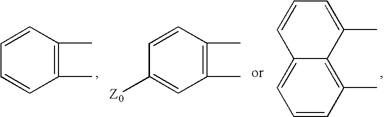

Z₀ is COOH or —COO—(C₁-C₂₀alkyl);
when n is 2, Z is a group of the formula

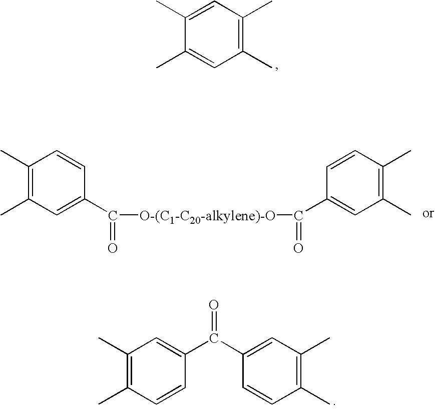

4) A polymer article as defined above, wherein component (B) is a compound of the formula

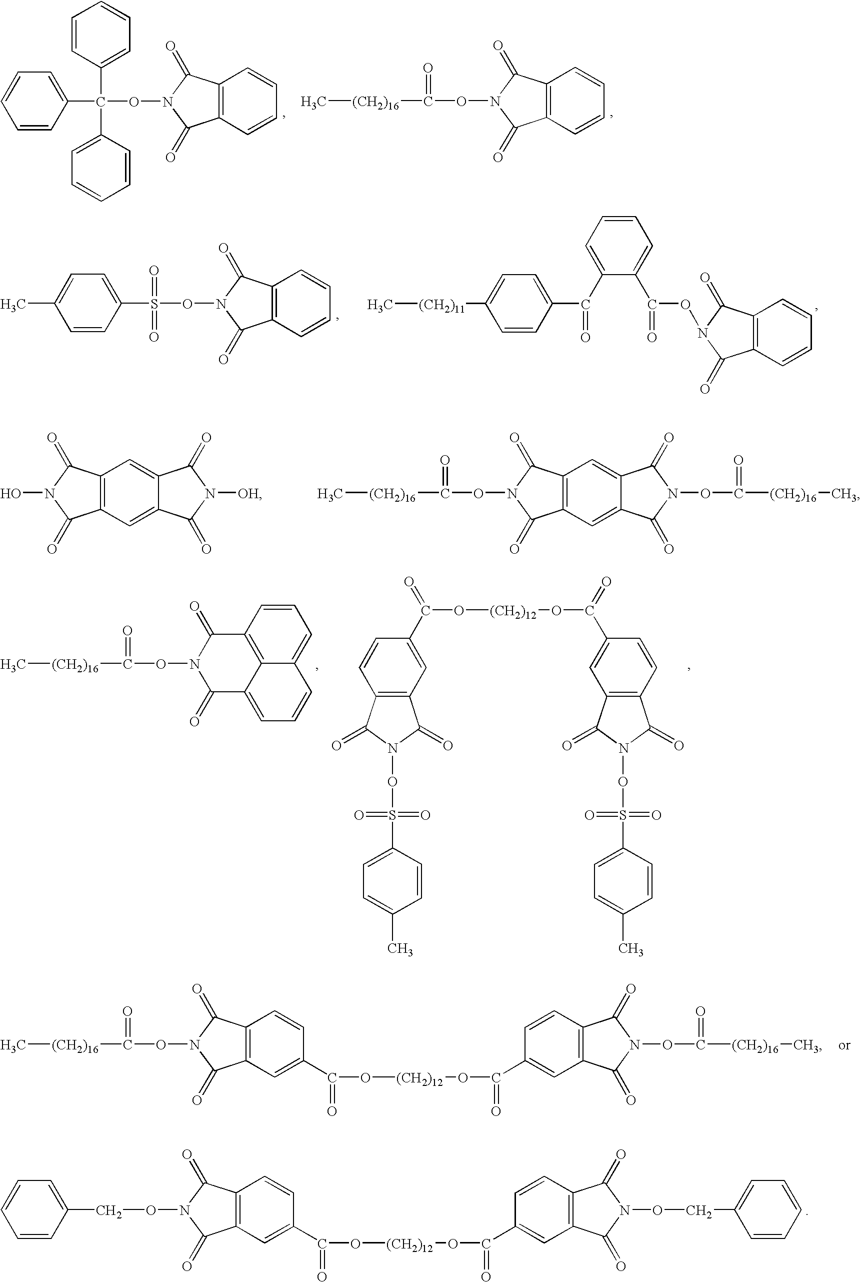

Further examples of compounds of the formula (I) are

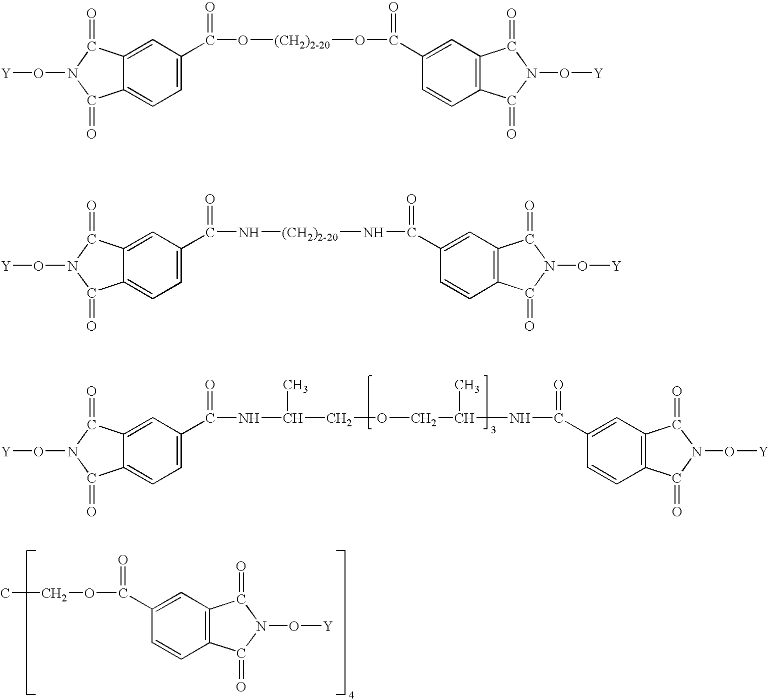

According to a preferred embodiment, the composition additionally contains a component (C) which is an inorganic or organic salt of a transition metal.

Component (C) is preferably a metal salt of a fatty acid with a carbon number ranging from C₂ to C₃₆, in particular from C₁₂ to C₃₆. Particularly preferred examples are metal carboxylates of palmitic acid (C₁₆), stearic acid (C₁₈), oleic acid (C₁₈), linoleic acid (C₁₈) and linolenic acid (C₁₈). Further examples of component (C) are aromatic acids, e.g. benzoic acid. Component (C) as C₂-C₃₆carboxylate of Fe, Ce, Co, Mn, Cu or V such as a C₁₂-C₂₀alkanoate or a C₁₂-C₂₀alkenoate is of particular interest.

Further examples of component (C) are

manganese titanate,
manganese borate*),
manganese potassium sulfate*),
manganese pyrophosphate*),
manganese sulfamate*),
manganese ferrite,
manganese(II) tetraborate, containing calcium carbonate,
manganese dioxide,
manganese sulfate*),
manganese nitrate*),
manganese chloride*), and
manganese phosphate*).
*) in hydrated or non-hydrated form

In general, the composition may additionally contain one or more conventional additives which are either commercially available or can be prepared according to known methods.

Examples are

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-d ioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1, 3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethyl butyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethyl benzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetramethylbutyl)-phenyl]-benzotriazole; 2-[2′-hydroxy-3′-(1,1,3,3-tetramethylbutyl)-5′-(α,α-dimethyl benzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.

2.5. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2, 4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-dicumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos® 168, Ciba Specialty Chemicals Inc.), tris(nonylphenyl) phosphite,

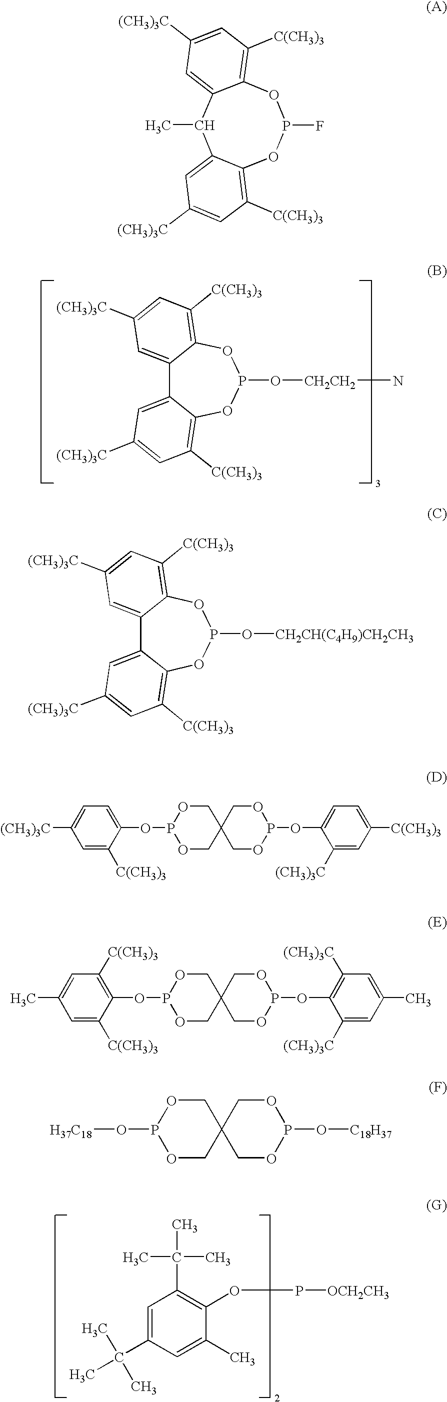

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

According to a preferred embodiment, the composition contains one or more of the following components

(D-I) a filler or reinforcing agent,
(D-II) a pigment,
(D-III) a light stabilizer,
(D-IV) a processing additive,
(D-V) an antioxidant,
(D-VI) an inorganic or organic salt of Ca, Mg, Zn or Al, or an oxide of Ca, Mg, Zn or Al,
(D-VII) a terpene derivative, an anthraquinone derivative and/or a benzophenone derivative,
(D-VIII) an inorganic oxidant.

Component (D-I) covers e.g. calcium carbonate, silicas, glass fibres, glass bulbs, talc, kaolin, mica, barium sulfate, metal oxides and hydroxides, carbon black, graphite, wood flour, flours of other natural products, synthetic fibers and metal stearates used as fillers such as calcium stearate or zinc stearate; unsaturated organic polymers such as polybutadiene, polyisoprene, polyoctenamer, or unsaturated acids such as stearic acid, oleic acid, linoleic acid or linolenic acid; and further polymers such as polyethylene oxide or polypropylene oxide.

Component (D-II) is for example carbon black, titanium dioxide (anatase or rutile which may range in particle size from e.g. 1000 μm to 10 nm and which may optionally be surface treated) or another organic or inorganic colour pigment frequently used in agricultural applications (for example carbon black, brown, silver, red, green).

Component (D-III) is preferably a hindered amine light stabilizer (HALS) or an UV absorber. Examples are disclosed in the above list of additives under item 2. Examples of preferred hindered amine light stabilizers are also those compounds which are disclosed for example as components (A), (B) and (C) in WO-A-01/92,392 which is incorporated by reference herein and which is equivalent to U.S. patent application Ser. No. 10/257,339.

Component (D-IV) is for example an antislip/antiblock additive, a plasticizer, an optical brightener, an antistatic agent or a blowing agent.

Component (D-V) is for example one of the antioxidants listed in the above additives list under item 1. A phenolic antioxidant is preferred.

Component (D-VI) is for example a metal stearate, e.g. calcium stearate or zinc stearate; or zinc oxide (which may range in particle size from e.g. 1000 μm to 10 nm and which may optionally be surface treated).

Component (D-VII) is for example a polyterpene resin of natural or synthetic origin. The polyterpenes are either commercially available or can be prepared according to known methods.

The polyterpene resins are for example based on acyclic terpenes or cyclic terpenes, e.g. monocyclic terpenes or bicyclic terpenes. Polyterpenes based on terpene hydrocarbons are preferred.

Examples of acyclic terpenes are

### Terpene Hydrocarbons, e.g.

myrcene, ocimene and beta-farnesene;

### Terpene Alcohols, e.g.

dihydromyrcenol (2,6-dimethyl-7-octen-2-ol), geraniol (3,7-dimethyl-trans-2,6-octadien-1-ol), nerol (3,7-dimethyl-cis-2,6-octadien-1-ol), linalool (3,7-dimethyl-1,6-octadien-3-ol), myrcenol (2-methyl-6-methylene-7-octen-2-ol), lavandulol, citronellol (3,7-dimethyl-6-octen-1-ol), transtrans-farnesol (3,7,11-trimethyl-2,6,10-dodecatrien-1-ol) and trans-nerolidol (3,7,11-trimethyl-1,6,10-dodecatrien-3-ol);

### Terpene Aldehydes and Acetals, e.g.

citral (3,7-dimethyl-2,6-octadien-1-al), citral diethyl acetal (3,7-dimethyl-2,6-octadien-1-aldiethyl acetal), citronellal (3,7-dimethyl-6-octen-1-al), citronellyloxyacetaldehyde and 2,6,10-trimethyl-9-undecenal;

### Terpene Ketones, e.g.

tagetone, solanone and geranylacetone (6,10-dimethyl-5,9-undecadien-2-one);

### Terpene Acids and Esters, e.g.

cis-geranic acid, citronellic acid, geranyl esters (including geranyl formate, geranyl acetate, geranyl propionate, geranyl isobutyrate and geranyl isovalerate), neryl esters (including neryl acetate), linalyl esters (including linalyl formate, linalyl acetate, linalyl propionate, linalyl butyrate and linalyl isobutyrate), lavandulyl esters (including lavandulyl acetate), citronellyl esters (including citronellyl formate, citronellyl acetate, cintronellyl propionate, citronellyl isobutyrate, citronellyl isovalerate and citronellyl tiglate); and

### Nitrogen Containing Unsaturated Terpene Derivatives, e.g.

cis-geranic acid nitrile and citronellic acid nitrile.

Examples of cyclic terpenes are

### Cyclic Terpene Hydrocarbons, e.g.

limonene (1,8-p-methadiene), alpha-terpinene, gamma-terpinene (1,4-p-menthadiene), terpinolene, alpha-phellandrene (1,5-p-menthadiene), beta-phellandrene, alpha-pinene (2-pinene), beta-pinene (2(10)-pinene), camphene, 3-carene, caryophyllene, (+)-valencene, thujopsene, alpha-cedrene, beta-cedrene and longifolene;

### Cyclic Terpene Alcohols and Ethers, e.g.

(+)-neoiso-isopulegol, isopulegol (8-p-menten-3-ol), alpha-terpineol (1-p-menten-8-ol), betaterpineol, gamma-terpineol, delta-terpineol and 1-terpinen-4-ol (1-p-menten-4-ol);

### Cyclic Terpene Aldehydes and Ketones, e.g.

carvone (1,8-p-mantadien-6-one), alpha-ionone (C₁₃H₂₀O), beta-ionone (C₁₃H₂₀O), gammaionone (C₁₃H₂₀O), irone (alpha-, beta-, gamma-) (C₁₄H₂₂O), n-methylionone (alpha-, beta-, gamma-) (C₁₄H₂₂O), isomethylionone (alpha-, beta-, gamma-) (C₁₄H₂₂O), allylionone (C₁₆H₂₄O), pseudoionone, n-methylpseudoionone, isomethylpseudoionone, damascones (1-(2,6,6-trimethylcycohexenyl)-2-buten-1-ones; including beta-damascenone (1-(2,6,6-trimethyl-1,3-cyclohadienyl)-2-buten-1-one)), nootkatone (5,6-dimethyl-8-isopropenylbicyclo[4.4.0]-1-decen-3-one) and cedryl methyl ketone (C₁₇H₂₆O); and

### Cyclic Terpene Esters, e.g.

alpha-terpinyl acetate (1-p-menthen-8-yl acetate), nopyl acetate ((−)-2-(6,6-dimethylbicyclo[3.1.1]hept-2-en-2-yl)ethyl acetate) and khusymil acetate.

Further suitable terpene derivatives can be found in Kirk-Othmer, Encyclopedia of Chemical Technology, John Wiley & Sons, 4. ed. (1994), Vol. 23, p. 833-882.

Preferred examples of terpenes which can serve as the basis for the polyterpenes are tricyclene, alpha-pinene, alpha-fenchene, camphene, beta-pinene, myrcene, cis-pinane, cis/trans-p-8-menthene, trans-2-p-menthene, p-3-menthene, trans-p-menthane, 3-carene, cis-p-menthane, 1,4-cineole, 1,8-cineole, alpha-terpinene, p-1-menthene, p-4(8)-menthene, limonene, p-cymene, gamma-terpinene, p-3,8-menthadiene, p-2,4(8)-menthadiene and terpinolene.

Further examples of component (D-VII) are cycloaliphatic compounds structurally related to terpenes such as the following

### Alcohols, e.g.

5-(2,2,3-trimethyl-3-cyclopenten-1-yl)-3-methylpentan-2-ol;

### Aldehydes, e.g.

2,4-dimethyl-3-cyclohexene carboxaldehyde, 4-(4-methyl-3-penten-1-yl)-3-cyclohexene carboxaldehyde and 4-(4-hydroxy-4-methylpentyl)-3-cyclohexene carboxaldehyde;

### Ketones, e.g.

civetone, dihydrojasmone (3-methyl-2-pentyl-2-cyclopenten-1-one), cis-jasmone (3-methyl-2-(2-cis-penten-1-yl)-2-cyclopenten-1-one), 5-cyclohexadecen-1-one, 2,3,8,8-tetramethyl-1,2,3,4,5,6,7,8-octahydro-2-napthalenyl methyl ketone and 3-methyl-2-cyclopenten-2-ol-1-one; and

### Esters, e.g.

4,7-methano-3a,4,5,6,7,7a-hexahydro-5-(or 6)-indenyl acetate, allyl 3-cyclohexylpropionate, methyl dihydrojasmonate methyl (3-oxo-2-pentylcyclopentyl)acetate.

The polyterpenes used in the present invention may also be derived from the copolymerisation of the aforementioned terpenes with other unsaturated organic compounds.

Other examples of component (D-VII) are the unsaturated coal-tar by-product polymers such as cumarone-indene resins, rosin and the like.

Present component (D-VII) is preferably a polyterpene resin selected from the group consisting of poly-alpha-pinene, poly-beta-pinene, polylimonene or a copolymer of alpha-pinene, a copolymer of beta-pinene or a copolymer of limonene. Poly-beta-pinene is particularly preferred.

Terpene-based hydrocarbon resins are typically based on products such as alpha-pinene, beta-pinene and d-limonene, which are obtained from the wood and citrus industry, respectively. Terpene-based resins have been available since the mid-1930s (Kirk-Othmer, Encyclopedia of Chemical Technology, John Wiley & Sons, 4. ed. (1994), Vol. 13, p. 717-718). Polymerization of monoterpenes is most commonly accomplished by carbocationic polymerization utilizing Friedel-Crafts-type catalyst systems, such as aluminum chloride (Kirk-Othmer, Encyclopedia of Chemical Technology, John Wiley & Sons, 4. ed. (1994), Vol. 1, p. 459).

In general, the polyterpenes of component (D-VII) have more than one terpene unit. They have preferably a molecular weight of about 400 g/mol to about 1400 g/mol.

Component (D-VIII) is in particular an inorganic peroxide or an inorganic superoxide, in particular of an alkali metal or an alkaline earth metal, or of a transition metal. Suitable examples of component (D-VIII) as a peroxide are magnesium peroxide (MgO₂), calcium peroxide (CaO₂), strontium peroxide (SrO₂), barium peroxide (BaO₂), lithium peroxide (Li₂O₂), sodium peroxide (Na₂O₂), potassium peroxide (K₂O₂), zinc peroxide (ZnO₂), silver peroxide (Ag₂O₂), copper peroxide or iron peroxide. Suitable examples of component (D-VIII) as a superoxide are lithium superoxide (LiO₂), sodium superoxide (NaO₂), potassium superoxide (KO₂), rubidium superoxide (RbO₂) and cesium superoxide (CsO₂). Preferred are lithium peroxide, sodium peroxide, magnesium peroxide, calcium peroxide, barium peroxide, zinc peroxide and potassium superoxide. Particularly preferred are sodium peroxide, magnesium peroxide, calcium peroxide and zinc peroxide. A comprehensive summary of inorganic peroxides or superoxides, which are useful for the present invention, is given in Kirk-Othmer, Encyclopedia of Chemical Technology, John Wiley & Sons, 4. ed. (1994), Vol. 18, pages 202-229, which is incorporated by reference herein. Blends of the abovementioned peroxides and/or superoxides can also be used.

Component (D-VIII) is preferably an inorganic peroxide of an alkali metal, an alkaline earth metal or a transition metal, or an inorganic superoxide of an alkali metal, an alkaline earth metal or a transition metal.

Further preferred examples of component (D-VIII) are magnesium peroxide, calcium peroxide, strontium peroxide, barium peroxide, lithium peroxide, sodium peroxide, potassium peroxide, zinc peroxide, silver peroxide, copper peroxide, iron peroxide, lithium superoxide, sodium superoxide, potassium superoxide, rubidium superoxide and cesium superoxide; in particular sodium peroxide, magnesium peroxide, calcium peroxide and zinc peroxide; especially calcium peroxide.

Component (D-VIII) is conveniently a compound which—when in contact with humidity—reacts with water in order to liberate an active auxiliary prodegradant species, and which is thermoprocessable in a temperature range between 100° and 300° C.

The polymer article according to the present invention can be any type of plastic article which needs an enhanced degradation in natural sunlight and/or humidity at low, ambient or elevated temperature.

For example, suitable polymer articles are plastic films, sheets, bags, bottles, styrofoam cups, plates, utensils, blister packages, boxes, package wrappings, plastic fibers, tapes, agricultural articles such as twine agricultural films, mulch films, small tunnel films, banana bags, direct covers, nonwoven, pots for agricultural use, goetextiles, landfill covers, industrial covers, waste covers, temporary scaffolding sheets, building films, silt fences, poultry curtains, films for building temporary shelter constructions, disposable diapers, disposable garments, and the like.

According to a preferred embodiment, the polymer article is an agricultural article which is for example selected from the group consisting of mulch films, row covers, small tunnel films, banana bags, direct covers, nonwoven, twines and pots.

A polymer article which is a monolayer or three-layers mulch film having a thickness of 5 to 100 microns with the provisos (1) and (2) being not applied is particularly preferred.

A polymer article which is a monolayer or three-layers mulch film having a thickness of 5 to 100 microns and being partly buried with soil, with the provisos (1) and (2) being not applied, is also preferred.

According to another preferred embodiment, the polymer article is a packaging material and/or which is used for consumer products (e.g. supermarket bags or refuse sacks).

The packaging material is in particular for food, beverage or cosmetics.

According to a further preferred embodiment, the polymer article is a hygienic or medical article.

Preferred is also a polymer article which is selected from the group consisting of films, fibers, profiles, bottles, tanks, containers, sheets, bags, styrofoam cups, plates, blister packages, boxes, package wrappings and tapes.

When the polymer article according to the present invention is useful for the construction area, it may be for example a geomembrane, a geotextile, a geogrid or a scaffolding film.

The polymer articles may be manufactured by any process available to those of ordinary skill in the art including, but not limited to, extrusion, extrusion blowing, film casting, film blowing, calendering, injection molding, blow molding, compression molding, thermoforming, spinning, blow extrusion and rotational casting.

A polymer article which is shaped by injection molding, blow molding, compression molding, roto molding, slush molding, extrusion, film casting, film blowing, calendering, thermoforming, spinning or rotational casting is particularly preferred.

Examples of component (A) are

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(II) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stepreoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 416, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Component (A) is preferably a thermoplastic synthetic polymer. Preferred examples are

a) Homo and copolymers of olefin monomers such as ethylene and propylene, but also higher 1-olefins such as 1-butene, 1-pentene, 1-hexene or 1-octen. Preferred is polyethylene LDPE and LLDPE, HDPE and polypropylene.

b) Homo- and copolymers of olefin monomers with diolefin monomers such as butadiene, isoprene and cyclic olefins such as norbornene.

c) Copolymers of one or more 1-olefins and/or diolefins with carbon monoxide and/or with other vinyl monomers, including, but not limited to, acrylic acid and its corresponding acrylic esters, methacrylic acid and its corresponding esters, vinyl acetate, vinyl ketone, styrene, maleic acid anhydride and vinyl chloride.

d) Polyvinyl alcohol

e) Other thermoplastics such as poly(meth)acrylate esters, polystyrene, styrene-acrylonitrile copolymer, acrylonitrile-butadiene-styrene copolymer, polyvinyl chloride, polyvinylidene chloride, polyvinyl acetate, polyvinylbutyral, ethylene-vinyl alcohol copolymer, polyethylene terephthalate (PET), polybutylene terephthalate (PBT), liquid crystal polyesters (LCPs), polyacetals (e.g., POM), polyamides (PA), polycarbonates, polyurethane and polyphenylene sulfide (PPS); polymer blends or polymer alloys formed of two or more of these resins; and compounds obtained by adding fillers such as glass fibers, carbon fibers, semi-carbonized fibers, cellulose fibers and glass beads, flame retardants, blowing agents, antimicrobial agents, crosslinking agents, fine polyolefin resin powder, polyolefin waxes, ethylene bisamide waxes, metallic soaps and the like either singly or in combination to these resins. Examples of thermosetting resins, on the other hand, can include thermosetting resins such as epoxy resins, melamine resins and unsaturated polyester resins; and compounds obtained by incorporating fillers such as glass fibers, carbon fibers, semi-carbonized fibers, cellulose fibers and glass beads, flame retardants and the like either singly or in combination to these resins.

Further preferred examples of component (A) are

polyethylensuccinate, polybutylensuccinate, polybutylensuccinate/adipate, polybutylensuccinate/carbonate, polybutylensuccinate/terephtalate, polycaprolactone, poly(hydroxyalcanoates), poly 3-hydroxybutyrate, polylactic acid, polyester amides, or blends of these materials with natural or modified starch, polysaccarides, lignin, wood flour, cellulose and chitin.

According to a particular preferred embodiment of the present invention component (A) is a polyolefin homo- or copolymer, a polyester homo- or copolymer, a polyamide homo- or copolymer, blends thereof, a starch modified polyolefin or a starch based polymer composite.

According to a further preferred embodiment of the present invention component (A) is polyethylene, polypropylene, a polyethylene copolymer or a polypropylene copolymer.

Component (B) is preferably present in the composition which forms the polymer article in an amount of 0.01 to 10%, preferably 0.01 to 5%, relative to the weight of component (A).

Component (C) is preferably present in the composition which forms the polymer article in an amount of 0.001 to 10%, preferably 0.005 to 5%, relative to the weight of component (A).

Component (D-I) is preferably present in the composition which forms the polymer article in an amount of 0.05 to 80%, preferably 0.5 to 70%, relative to the weight of component (A).

Component (D-II) is preferably present in the composition which forms the polymer article in an amount of 0.05 to 40%, preferably 0.05 to 30%, relative to the weight of component (A).

Component (D-III) is preferably present in the composition which forms the polymer article in an amount of 0.01 to 20%, preferably 0.01 to 10%, relative to the weight of component (A).

Component (D-IV) is preferably present in the composition which forms the polymer article in an amount of 0.05 to 10%, preferably 0.05 to 5%, relative to the weight of component (A).

Component (D-V) is preferably present in the composition which forms the polymer article in an amount of 0.005 to 1%, preferably 0.01 to 0.3%, relative to the weight of component (A).

Component (D-VI) is preferably present in the composition which forms the polymer article in an amount of 0.005 to 5%, preferably 0.05 to 1%, relative to the weight of component (A).

Component (D-VII) is preferably present in the composition which forms the polymer article in an amount of 0.01 to 10%, preferably 0.01 to 5%, relative to the weight of component (A).

Component (D-VIII) is preferably present in the composition which forms the polymer article in an amount of 0.005 to 20%, preferably 0.1 to 15%, relative to the weight of component (A).

A further embodiment of the present invention is the use of a compound of the formula (I) for the acceleration of the degradation of a natural and/or synthetic polymer in the presence of light and/or heat and/or humidity.

Still a further embodiment of the present invention is a process for accelerating the degradation of a natural and/or synthetic polymer in the presence of light and/or heat and/or humidity, which comprises incorporating into the natural and/or synthetic polymer a compound of the formula (I).

Some compounds of the formula (I) are novel. Thus, further embodiments of the present invention are:

### EMBODIMENT A

A compound of the formula (IA)

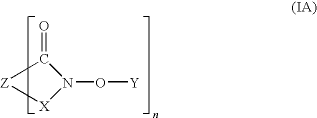

wherein
n is 1, 2 or 4;

### X is >C═O;

Y is C₁-C₃₀alkyl, C₃-C₁₂cycloalkyl unsubstituted or substituted by 1, 2 or 3 C₁-C₄alkyl; C₅-C₁₂cycloalkenyl unsubstituted or substituted by 1, 2 or 3 C₁-C₄alkyl; a bicyclic or tricyclic hydrocarbyl having 6 to 10 carbon atoms, C₇-C₉phenylalkyl unsubstituted or substituted on the phenyl by 1, 2 or 3 C₁-C₄alkyl; diphenylmethyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, —Si(Y₁₁)₃ or —Si(OY₂)₃;
Y₀, Y₁ and Y₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
and
when n is 1, Z is a group of the formula (I-b), (I-c), (I-j), (I-k), (I-l) or (I-m)

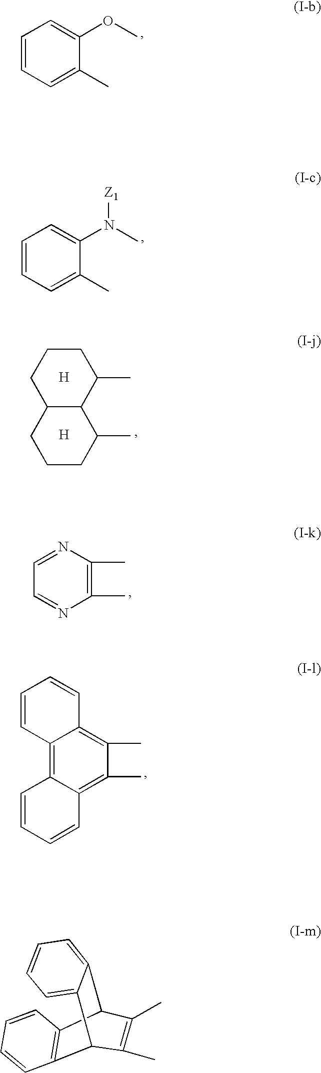

the aromatic rings of the formulae (I-b), (I-c) and (I-k) to (I-m) and the residue of the formula (I-j) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₁₀₀, Z₁₀₁, Z₁₀₂ and Z₁ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and
when n is 2, Z is a group of the formula (II-a), (II-b), (II-c) or (II-d),

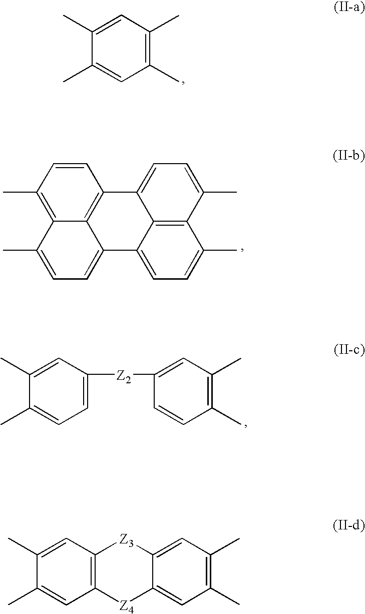

the aromatic rings of the formulae (II-a) to (II-c) are optionally substituted by one or more radicals selected from the group consisting hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₂ is >C═O, —O—, —S—, >N—R₁, >S═O or —S(O)₂—, C₃-C₃₀diacyl, C₃-C₃₀di(acyloxy), C₃-C₄₅dicarboxylate, C₃-C₄₅di(carboxamide), diamine or diamide;
Z₃ and Z₄ independently of one another are >C═O, —O—, —S—, >N—R₂, >S═O or —S(O)₂—;
R₁ and R₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and
when n is 4, Z is a group of the formula (III-a)

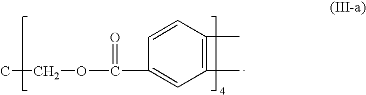

Particular preferred compounds of the formula (IA) are

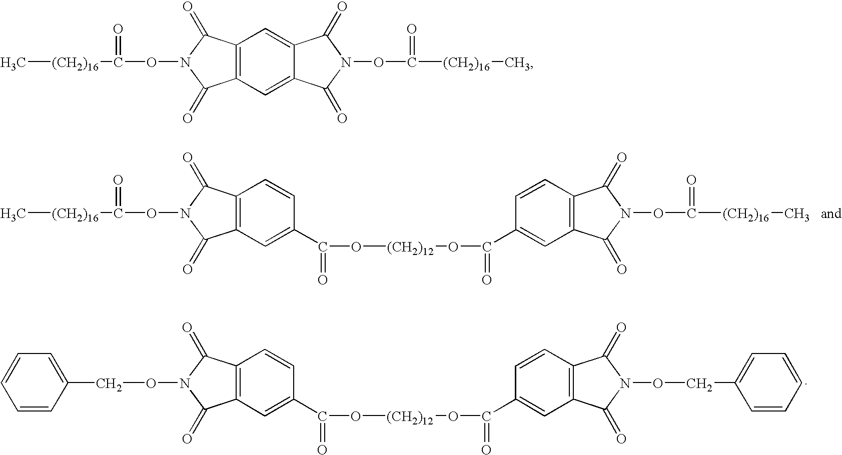

### EMBODIMENT B

A compound of the formula (IB)

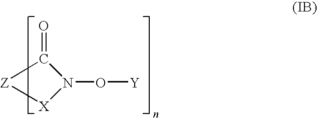

wherein
n is 1, 2 or 4;

### X is >S(O)₂ or >C(X₁)(X₂);

X₁ and X₂ independently of one another are hydrogen, C₁-C₂₀alkyl, C₃-C₁₂cycloalkyl unsubstituted or substituted by 1, 2 or 3 C₁-C₄alkyl; or phenyl unsubstituted or substituted by 1, 2 or 3 C₁-C₄alkyl;
Y is C₁-C₃₀alkyl, C₂-C₃₀alkenyl, C₃-C₁₂cycloalkyl unsubstituted or substituted by 1, 2 or 3 C₁-C₄alkyl; C₅-C₁₂cycloalkenyl unsubstituted or substituted by 1, 2 or 3 C₁-C₄alkyl; a bicyclic or tricyclic hydrocarbyl having 6 to 10 carbon atoms, C₇-C₉phenylalkyl unsubstituted or substituted on the phenyl by 1, 2 or 3 C₁-C₄alkyl; diphenylmethyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, C₁-C₃₀sulfonyl, —Si(Y₁)₃ or —Si(OY₂)₃;
Y₀, Y₁ and Y₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
and
when n is 1, Z is a group of the formula (I-a), (I-b), (I-c), (I-d), (I-e), (I-f), (I-g), (I-h), (I-i), (I-j), (I-k), (I-l), (I-m) or (I-n),

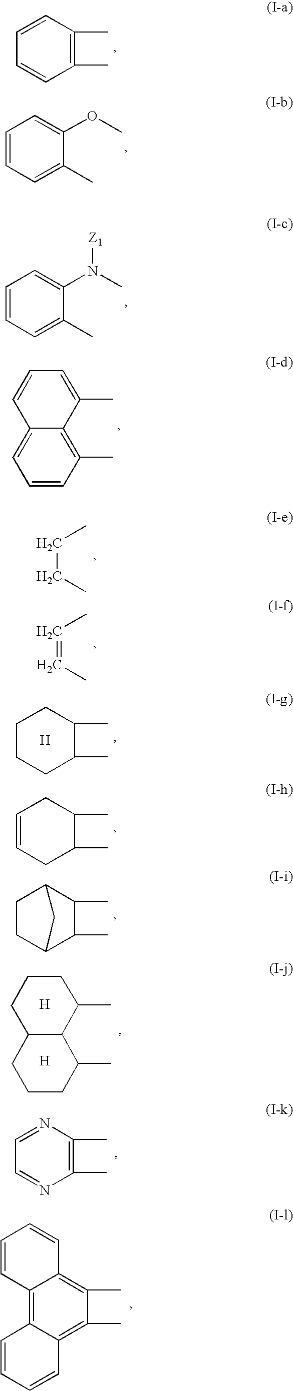

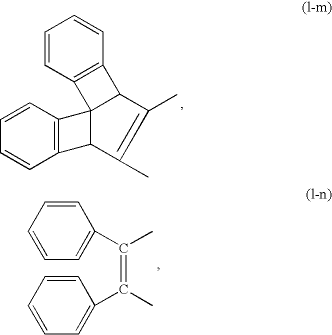

the aromatic rings of the formulae (I-a) to (I-d), (I-k) to (I-n) and the residues of the formulae (I-e) to (I-j) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₁₀₀, Z₁₀₁, Z₁₀₂ and Z₁ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
when n is 2, Z is a group of the formula (II-a), (II-b), (II-c) or (II-d),

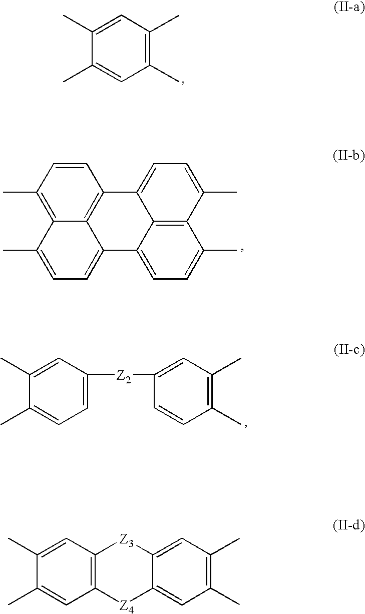

the aromatic rings of the formulae (II-a) to (II-c) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₂ is >C═O, —O—, —S—, >N—R₁, >S═O or —S(O)₂—, C₃-C₃₀diacyl, C₃-C₃₀di(acyloxy), C₃-C₄₅dicarboxylate, C₃-C₄₅di(carboxamide), diamine or diamide;
Z₃ and Z₄ independently of one another are >C═O, —O—, —S—, >N—R₂, >S═O or —S(O)₂—;
R₁ and R₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and
when n is 4, Z is a group of the formula (III-a)

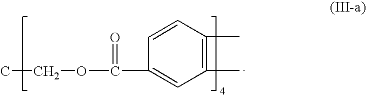

### EMBODIMENT C

A compound of the formula (IC)

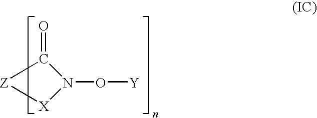

wherein
n is 1, 2 or 4;

### X is >S(O)₂ or >C(X₁)(X₂);

X₁ and X₂ independently of one another are hydrogen, C₁-C₂₀alkyl, C₃-C₁₂cycloalkyl unsubstituted or substituted by 1, 2 or 3 C₁-C₄alkyl; or phenyl unsubstituted or substituted by 1, 2 or 3 C₁-C₄alkyl;
Y is hydrogen; and
when n is 1, Z is a group of the formula (I-b), (I-c), (I-j), (I-k), (I-l) or (I-m),

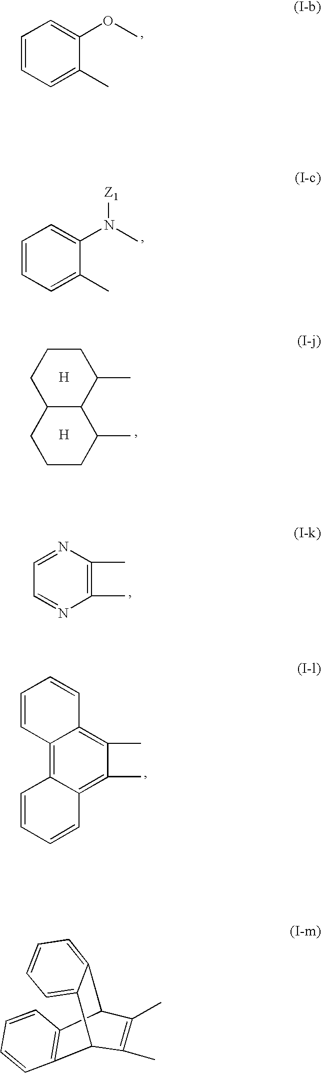

the aromatic rings of the formulae (I-b), (I-c), (I-k) to (I-m) and the residue of the formula (I-j) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₁₀₀, Z₁₀₁, Z₁₀₂ and Z₁ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and
when n is 2, Z is a group of the formula (II-a), (II-b), (II-c) or (II-d),

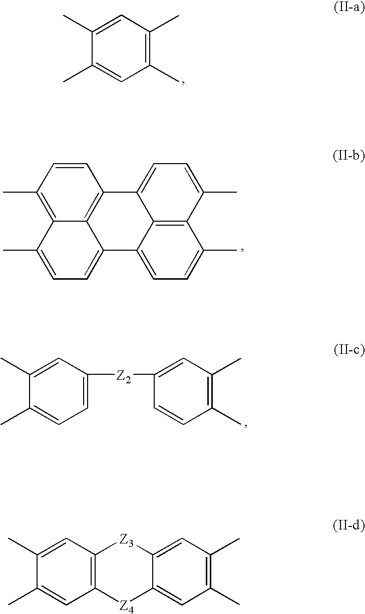

the aromatic rings of the formulae (II-a) to (II-c) are optionally substituted by one or more radicals selected from the group consisting of hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₂ is >C═O, —O—, —S—, >N—R₁, >S═O or —S(O)₂—, C₃-C₃₀diacyl, C₃-C₃₀di(acyloxy), C₃-C₄₅dicarboxylate, C₃-C₄₅di(carboxamide), diamine or diamide;
Z₃ and Z₄ independently of one another are >C═O, —O—, —S—, >N—R₂, >S═O or —S(O)₂—;
R₁ and R₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl; and
when n is 4, Z is a group of the formula (III-a)

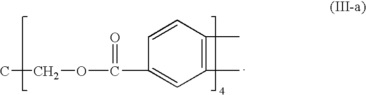

Of interest is also a compound of the formula

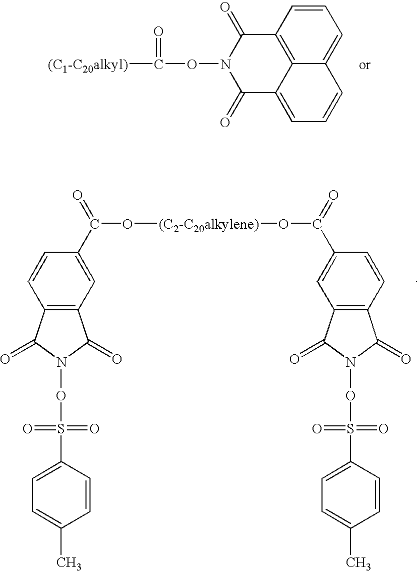

The preferred embodiments of the compounds of the formulae (IA), (IB) and (IC) correspond in appropriate manner to those described above for the compounds of the formula (I).

The compounds of the formula (I) as well as the novel compounds described above can be prepared according to known processes (e.g. as described in U.S. Pat. No. 6,316,639), preferably in analogy to the methods described in the following examples.

The examples below illustrate the invention in greater detail. All percentages and parts are by weight, unless stated otherwise.

The compounds of the following Examples 2, 10, 14, 15 and 16 are particularly preferred.

### EXAMPLE 1

### Preparation of N-trityloxyphthalimide

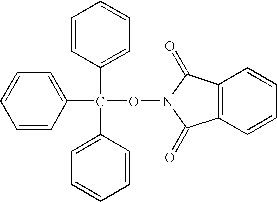

The synthesis of N-trityloxyphthalimide is performed by reacting 55.0 g of N-hydroxyphthalimide and 55.9 g of potassium carbonate in the presence of 700 ml of N,N-dimethylacetamide. Upon the addition of 103.3 g of tritylchloride to the mixture of the educts, the reaction mixture is maintained to 20° C. for 16 h. The solvent of the reaction is evaporated at reduced pressure and the obtained mass is poured into dichloromethane solution, the organic phase is washed several times with water and concentrated under vacuum. N-trityloxyphthalimide is obtained, crystallizing with acetonitrile, as white crystalline solid.

Melting point: 180-186° C.

### EXAMPLE 2

### Preparation of N-stearoyloxyphthalimide

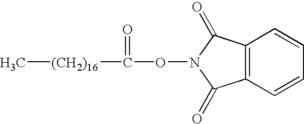

The synthesis of N-stearoyloxyphthalimide is performed by reacting 16.3 g of N-hydroxyphthalimide and 20.2 g of triethylamine in the presence of 150 ml of dichloromethane. Upon the addition of 33.0 g of stearoylchloride to the mixture of the educts, the reaction mixture is maintained to 30° C. for 6 h. The reaction mass is poured into 100 ml of water, the organic phase is separated and concentrated under vacuum. N-stearoyloxyphthalimide is obtained as white crystalline solid.

Melting point: 76-80° C.

### EXAMPLE 3

### Preparation of N-p-toluene-4-sulfonyloxyphthalimide

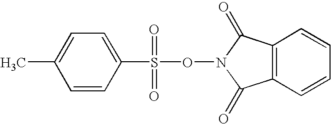

The synthesis of N-p-toluene-4-sulfonyloxyphthalimide is performed by reacting 16.3 g of N-hydroxyphthalimide and 20.2 g of triethylamine in the presence of 200 ml of dichloromethane. Upon the addition of 20.0 g of p-toluenesulfonyl chloride to the mixture of the educts, the reaction mixture is maintained to 25° C. for 2 h. The reaction mass is filtered off and poured into 200 ml of water, the organic phase is separated and concentrated under vacuum. N-p-toluene-4-sulfonyloxyphthalimide is obtained as slightly yellow solid.

Melting point: 157-164° C.

### EXAMPLE 4

### Preparation of N-2-(4-dodecylbenzoyl)benzoyloxyphthalimide

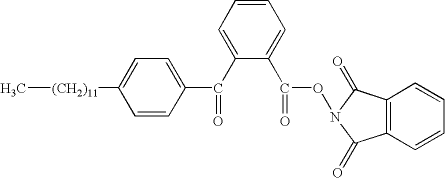

N-2-(4-dodecylbenzoyl)benzoyloxyphthalimide is obtained in a three-step synthesis:

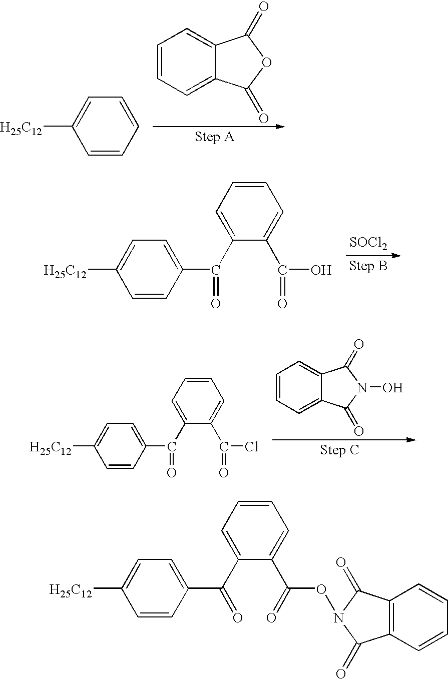

Step A: The synthesis of 2-(4-dodecylbenzoyl)benzoic acid is performed by reacting 45.0 g of dodecylbenzene and 29.8 g of phthalic acid anhydride in a Friedel-Crafts reaction in the presence of 500 ml of chloroform. Upon the addition of 58.5 g of AlCl₃ to the mixture of the educts, a slight exotherme is observed, followed by an evolvement of HCl gas for 1.5 hours. After the gas formation has ceased, the reaction mixture is brought to boiling until gas formation is observed again, and refluxed for another 5 hours until no more HCl gas is formed. After being cooled to room temperature, the reaction mass is poured into 300 ml of water, acidified with HCl and filtered. The crude product is washed with water until a pH of seven is reached. The product obtained (2-(4-dodecylbenzoyl)benzoic acid) is a white crystalline solid with a melting point of 85° C.

Step B: A four-necked round-bottom flask equipped with a mechanical stirrer, thermocouple, dropping funnel and condenser is charged successively with 3.0 g of 2-(4-dodecylbenzoyl)benzoic acid obtained according to Step A and 30 ml of dichloromethane. The mixture is cooled to 0° C. and 2.7 g of thionyl chloride are dropped to the solution. The reaction is left at 20° C. for 20 hours and then concentrated under reduced pressure. 2-(4-dodecylbenzoyl)benzoyl chloride is obtained as yellow oil (confirmation of the structure by NMR analysis).

Step C: A four-necked round-bottom flask equipped with a mechanical stirrer, thermocouple, dropping funnel and condenser is charged successively with 1.0 g of 2-(4-dodecylbenzoyl)-benzoyl chloride obtained according to Step B, 20 ml of dichloromethane and 0.8 g of pyridine. 0.34 g of N-hydroxyphthalimide are poured into the mixture stirred at room temperature. The reaction is left at 20° C. for 20 hours and then 20 ml of water are added to the reaction mixture. The organic phase is separated and N-2-(4-dodecylbenzoyl)benzoyloxyphthalimide is obtained as white solid by crystallization with n-hexane.

Melting point: 83-92° C.

### EXAMPLE 5

### Preparation of N—N′-dihydroxypyromellitic diimide

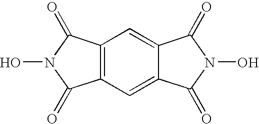

A four-necked round-bottom flask equipped with a mechanical stirrer, thermocouple, dropping funnel and condenser is charged successively with 2000 ml of ethanol, 104.0 g of hydroxylamine hydrochloride, 204.4 g of triethylamine and 220.2 g of pyromellitic dianhydride. The mixture is heated to reflux temperature and left to stir at this temperature for 6 hours. Upon cooling to room temperature, 2000 ml of water are poured into the reaction mixture. The precipitated solid is filtered off and dried under vacuum at 140° C. N—N′-dihydroxypyromellitic diimide is obtained as yellow solid.

Melting point: >295° C.

### EXAMPLE 6

### Preparation of N,N′-bis[stearoyloxy]pyromellitic diimide

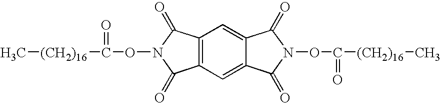

A four-necked round-bottom flask equipped with a mechanical stirrer, thermocouple, dropping funnel and condenser is charged successively with 70 ml of tetrahydrofuran, 5.0 g of N—N′-dihydroxypyromellitic diimide obtained according to Example 5 and 4.2 g of triethylamine. Then, 13.4 g of stearoyl chloride in 30 ml of tetrahydrofuran are dropped to the mixture at 20° C. The mixture is left to stir at room temperature for 6 hours. The reaction mixture is concentrated under reduced pressure. N,N′-bis[stearoyloxy]pyromellitic diimide crystallized from toluene/ethanol is recovered as white solid.

Melting point: 133-138° C.

### EXAMPLE 7 (INTERMEDIATE)

### Preparation of N-hydroxyphthalimide-4-carboxylic acid

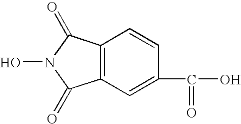

A four-necked round-bottom flask equipped with a mechanical stirrer, thermocouple, dropping funnel and condenser is successively charged with 140 ml of ethanol, 7.3 g of hydroxylamine hydrochloride and 21.0 g of triethylamine. 20.0 g of trimellitic anhydride are slowly added to the stirred mixture and then, the reaction mixture is heated to reflux temperature and left to stir at this temperature for 15 hours. Upon cooling to room temperature, 150 ml of water and 150 ml of tert-amyl alcohol are poured into the reaction mixture and acidified with diluted HCl to pH<2. The tert-amylalcohol phase is separated and concentrated under reduced pressure. N-hydroxyphthalimide-4-carboxylic acid is obtained as crude yellow solid.

Melting point: 227-232° C.

### EXAMPLE 8 (INTERMEDIATE)

### Preparation of 4-lauryloxycarbonyl-N-hydroxyphthalimide

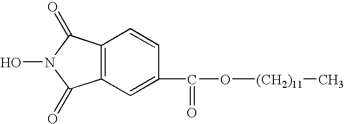

A four-necked round-bottom flask equipped with a mechanical stirrer, thermocouple, dropping funnel and condenser is successively charged with 10 ml of hexane, 2.0 g of N-hydroxyphthalimide-4-carboxylic acid, as obtained in the Example 7, 30 ml of lauryl alcohol and 0.19 g of p-toluensulfonic acid. The reaction mixture is heated up to reflux temperature and left to stir for 6 hours. The organic phase is then filtered and partially concentrated under vacuum. The 4-lauryloxycarbonyl-N-hydroxyphthalimide is obtained as white solid by recrystallization with methanol.

Melting point: 96°-105° C.

### EXAMPLE 9 (INTERMEDIATE)

### Preparation of N-hydroxy-1,8-naphthalimide

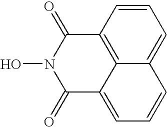

A four-necked round-bottom flask equipped with a mechanical stirrer, thermocouple, dropping funnel and condenser is successively charged with 500 ml of ethanol, 10.2 g of triethylamine and 7.0 g of hydroxylamine hydrochloride. The stirred mixture is then heated up at 40° C. and when an homogeneous solution is obtained, 20.0 g of 1,8-naphthalic anhydride are added. The reaction mixture is maintained at reflux temperature for 8 hours and upon cooling at room temperature the precipitate is separated by filtering off the solution, washed with water and dried in oven under vacuum at 130° C. The N-hydroxy-1,8-naphthalimide is obtained as pink solid.

Melting point: 285°-288° C.

### EXAMPLE 10

### Preparation of N-stearoyloxy-1,8-naphthalimide

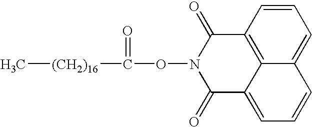

A four-necked round-bottom flask equipped with a mechanical stirrer, thermocouple, dropping funnel and condenser is successively charged with 80 ml of N,N-dimethylacetamide, 4.0 g of N-hydroxy-1,8-naphthalimide as obtained in the Example 9 and 1.95 g of triethylamine. 6.97 g of stearoyl chloride are added dropwise to the heterogeneous solution at room temperature. The reaction is left under stirring at 70° C. for 6 hours and then concentrated under vacuum. The residue is dissolved in dichloromethane and the organic phase is washed with water, filtered on Tonsyl 414/FF and concentrated under vacuum. After recrystallizing with methanol/hexane 20:1, the N-stearoyloxy-1,8-naphthalimide is obtained as white solid.

Melting point: 72°-80° C.

### EXAMPLE 11

### Preparation of N-octyloxy-4-carboxylic acid octyl ester

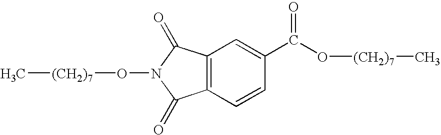

A four-necked round-bottom flask equipped with a mechanical stirrer, thermocouple, dropping funnel and condenser is charged at room temperature successively with 0.60 g of N-hydroxyphthalimide-4-carboxylic acid, obtained according to Example 7, 20 ml of N,N-dimethylacetamide, 2.49 g of n-bromo octane and 1.78 g of K₂CO₃. The reaction is heated up at 70° C. and stirred for 10 hours. Then, 100 ml of water and 100 ml of dichloromethane are added to the reaction mixture at room temperature. The organic phase is separated and concentrated under reduced pressure and N-octyloxy-4-carboxylic acid octyl ester is obtained as a white solid by recrystallization with ethanol.

Melting point: 55-59° C.

### EXAMPLE 12

### Preparation of N-octadecyloxyphthalimide

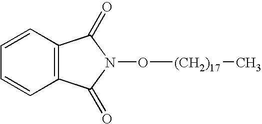

A four-necked round-bottom flask equipped with a mechanical stirrer, thermocouple, dropping funnel and condenser is charged at room temperature successively with 32.0 g of N-hydroxyphthalimide, 350 ml of N,N-dimethylacetamide, 66.6 g of n-bromo octadecane and 44.0 g of K₂CO₃. The reaction is heated up at 100° C. and left to react for 3 hours under stirring. The mixture is filtered and concentrated under reduced pressure. N-octadecyloxyphthalimide is obtained as a white solid by ethanol recrystallization of the crude.

Melting point: 82-88° C.

### EXAMPLE 13

### Preparation of 1,12-bis[4-carboxy-N-hydroxyphthalimide]dodecyl diester

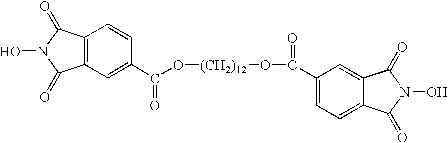

1,12-bis[4-carboxy-N-hydroxyphthalimide]dodecyl diester is obtained in a two-step synthesis as reported below:

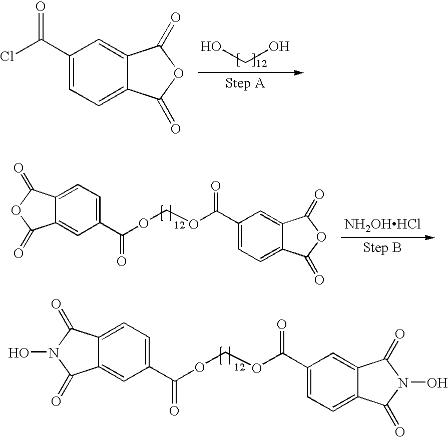

Step A: A four-necked round-bottom flask equipped with a mechanical stirrer, thermocouple, dropping funnel and condenser is charged successively with 200 g of trimellitic anhydride acid chloride, 800 ml of N,N-dimethylacetamide and 85.8 g of pyridine. The mixture is cooled at −5° C. and, under stirring, 91.5 g of 1,12 dodecanediol in 400 ml of N,N-dimethylacetamide are dropped to the mixture. The mixture is spontaneously left to rise at room temperature and left to react for 3 hours. Then, the reaction mixture is filtered and concentrated under vacuum. 1,12-bis[4-carboxy-phthalic anhydride]dodecyl diester is obtained as a crude white solid.

Melting point: 134-139° C.

Step B: A four-necked round-bottom flask equipped with a mechanical stirrer, thermocouple, dropping funnel and condenser is successively charged with 300 ml of ethanol, 34.1 g of hydroxylamine hydrochloride and 38.8 g of pyridine. The mixture is maintained under stirring for 30 minutes. Then, 135.0 g of 1,12-bis[4-carboxy-phthalic anhydride]dodecyl diester are slowly added to the stirred mixture. Subsequently, the reaction mixture is heated to reflux temperature and 80 ml of solvent are distilled off in 3 hours. Successively, 700 ml of tert-amyl alcohol are added to the mixture. The reaction mixture is heated to reflux temperature for 7 hours, then upon cooling to room temperature, the precipitated solid is separated by filtering off the solution, washed with water and exsiccated under vacuum. 1,12-Bis[4-carboxy-N-hydroxyphthalimide]dodecyl diester is obtained as a crude white solid.

Melting point: 170-176° C.

### EXAMPLE 14

### Preparation of 1,12-bis(4-carboxy-N-stearoyloxyphthalimide) dodecyl diester

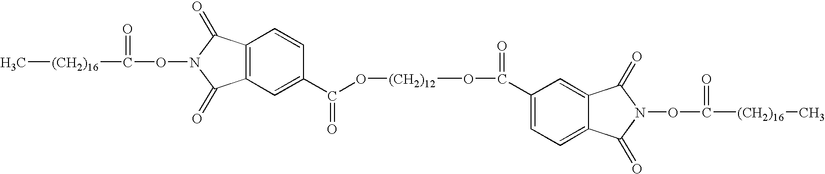

A four-necked round-bottom flask equipped with a mechanical stirrer, thermocouple, dropping funnel and condenser is successively charged with 94.5 g of 1,12-bis(4-carboxy-N-hydroxyphthalimide) dodecyl diester, as prepared in Example 13, and 33.9 g of triethylamine in the presence of 2 L of tetrahydrofuran (THF). Upon the addition of 108.4 g of stearoylchloride to the mixture of the educts, the reaction mixture is maintained to 30° C. for 16 h. Then, the precipitated solid is separated from the crude mixture by filtering off the solution and recrystallized with EtOH. The 1,2-bis(4-carboxy-N-stearoyloxyphthalimide) dodecyl diester is obtained as an off-white crystalline solid.

Melting point: 111°-117° C.

### EXAMPLE 15

### Preparation of 1,12-bis[4-carboxy-N-tosyloxyphthalimide]dodecyl diester

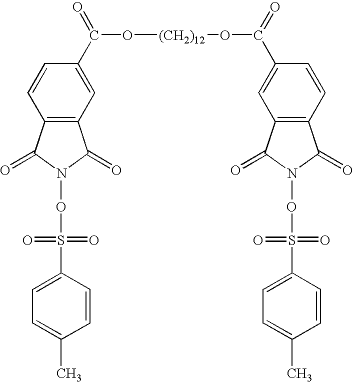

A four-necked round-bottom flask equipped with a mechanical stirrer, thermocouple, dropping funnel and condenser is charged at room temperature successively with 25.0 g of 1,12-bis[4-carboxy-N-hydroxyphthalimide]dodecyl diester, as prepared in the Example 13, 500 ml of tetrahydrofuran (THF) and 13.0 g of triethylamine. 16.9 g of p-toluenesulfonyl chloride are added in portion to the stirred mixture maintained at 20° C. The reaction is left to react under stirring for 16 hours at 20° C. Then, the organic phase is filtered and concentrated under reduced pressure. 1,12-bis(4-carboxy-N-tosyloxyphthalimide]dodecyl diester is obtained as a white solid by recrystallization of the crude product with ethanol/acetonitrile (2:1).

Melting point: 111-118° C.

### EXAMPLE 16

### Preparation of 1,12-bis[4-carboxy-N-benzyloxyphthalimide]dodecyl diester

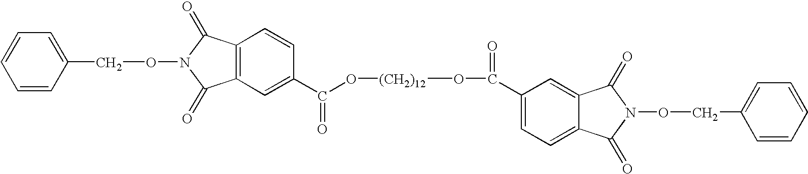

A four-necked round-bottom flask equipped with a mechanical stirrer, thermocouple, dropping funnel and condenser is charged at room temperature successively with 20.3 g of 1,12-bis[4-carboxy-N-hydroxyphthalimide]dodecyl diester, as prepared in the Example 13, 300 ml of N,N-dimethylacetamide, 11.6 g of K₂CO₃ and 13.2 g of benzyl bromide. The mixture is heated to 70° C. under stirring and left to react for 2 hours and then cooled to 20° C. The precipitated solid is washed with water and acetonitrile and then exsiccated under reduced pressure. 1,12-bis[4-carboxy-N-benzyloxyphthalimide]dodecyl diester is obtained as a white solid.

Melting point: 173-178° C.

### EXAMPLE 17

### Preparation of 1,12-bis[4-carboxy-N-isopropyloxyphthalimide]dodecyl diester

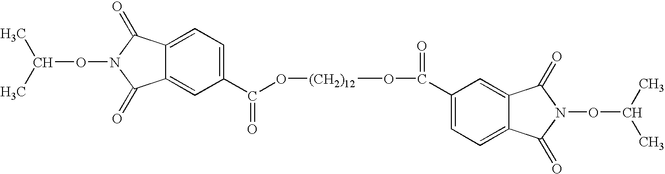

A four-necked round-bottom flask equipped with a mechanical stirrer, thermocouple, dropping funnel and condenser is charged at room temperature successively with 5.0 g of 1,12-bis[4-carboxy-N-hydroxyphthalimide]dodecyl diester, as prepared in the Example 13, 75 ml of N,N-dimethylacetamide, 2.8 g of K₂CO₃ and 2.3 g of 2-bromopropane. Under stirring, the mixture is heated to 70° C. and left to react for 8 hours and then cooled to 20° C. The precipitated solid is washed with water and acetone and then exsiccated under reduced pressure. 1,12-bis[4-carboxy-N-isopropyloxyphthalimide]dodecyl diester is so obtained as a white solid.

Melting point: 149-156° C.

### EXAMPLE 18

### Preparation of N,N′-dihydroxy-benzophenonediimide

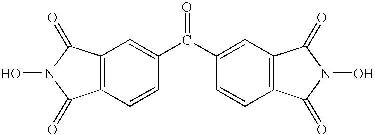

A four-necked round-bottom flask equipped with a mechanical stirrer, thermocouple, dropping funnel and condenser is charged at room temperature successively with 32.2 g of 3,3′,4,4′-benzophenonetetracarboxylic dianhydride and 120 ml of dimethylformamide (DMF). The mixture is cooled to 0° C. Then, a solution of 13.9 g of hydroxylamine hydrochloride and 117.8 g of pyridine is slowly dropped to the stirred mixture maintained at 0° C. Then, the reaction mixture is heated at 95-105° C. for 1 hour and concentrated under vacuum. 100 ml of 1N acetic acid solution are added to the crude product and the precipitated solid is separated from the solution and washed with water. After recrystallization with ethanol the precipitated solid is dried in an oven at reduced pressure and N,N-dihydroxy-benzophenonediimide is obtained as a white solid.

Melting point: 288-295° C.

### EXAMPLE 19

### Preparation of N,N′-distearoyloxy-benzophenonediimide

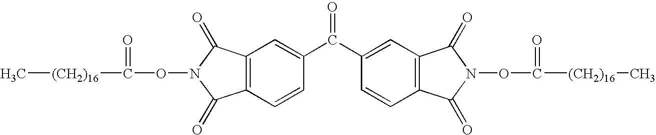

A four-necked round-bottom flask equipped with a mechanical stirrer, thermocouple, dropping funnel and condenser is charged at room temperature successively with 25.0 g of N,N-dihydroxy-benzophenonediimide as obtained in the Example 18, 500 ml of tetrahydrofuran (THF) and 21.5 g of triethylamine. 45.1 g of stearoyl chloride are added in portions to the stirred mixture. The reaction is maintained at 20° C. for 16 hours and then concentrated under vacuum. The crude product is washed with ethanol and dried in an oven at reduced pressure. N,N′-distearoyloxy-benzophenonediimide is obtained as a white solid.

Melting point: 109-115° C.

### EXAMPLE 20

### Preparation of N-(tert-butyldiphenylsilanyloxy)-phthalimide

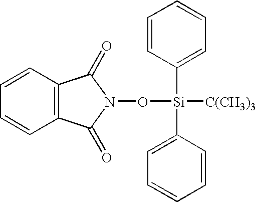

A four-necked round-bottom flask equipped with a mechanical stirrer, thermocouple, dropping funnel and condenser is charged at room temperature successively with 1.6 g of N-hydroxyphthalimide, 30 ml of tetrahydrofuran (THF) and 2.0 g of triethylamine. Then, 2.7 g of tert-butyldiphenylchlorosilane in 10 ml of THF are dropped to the mixture maintained under stirring for 4 hours at 20° C. The mixture is then filtrated and the solution phase is concentrated under vacuum. 50 ml of hexane are added to the crude product and the organic phase is filtrated and concentrated under vacuum. N-(tert-butyldiphenylsilanyloxy)phthalimide is obtained as white solid.

Melting point: 138-143° C.

### EXAMPLE 21

### Preparation of carbonic acid 1,3-dioxo-1,3-dihydro-isoindol-2-yl ester octadecyl ester

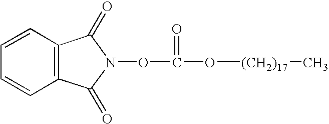

A four-necked round-bottom flask equipped with a mechanical stirrer, thermocouple, dropping funnel and condenser is charged at room temperature successively with 10.0 g of N-hydroxyphthalimide and 200 ml of tetrahydrofuran (THF). The mixture is cooled to −5° C. and 24.4 g of octadecyl chloroformate in 50 ml of THF and subsequently 8.7 g of triethylamine in 50 ml of THF are dropped to the mixture. Then, the reaction is spontaneously left to rise to room temperature and maintained under stirring for 2 hours. The reaction mixture is filtered and the organic phase is concentrated under reduced pressure. The crude product is recrystallized with isopropanol and the precipitated solid is separated by filtering off the solution and dried under vacuum. Carbonic acid 1,3-dioxo-1,3-dihydro-isoindol-2-yl ester octadecyl ester is obtained as a white solid.

Melting point: 83-89° C.

### EXAMPLE 22

### Preparation of carbonic acid 1,3-dioxo-1,3-dihydro-isoindol-2-yl ester methyl ester

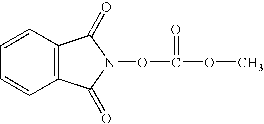

A four-necked round-bottom flask equipped with a mechanical stirrer, thermocouple, dropping funnel and condenser is charged at room temperature successively with 3.26 g of N-hydroxyphthalimide and 100 ml of tetrahydrofuran (THF). The mixture is cooled to −5° C. and 2.65 g of methyl chloroformate in 20 ml of THF are added. Subsequently, 3.04 g of triethylamine in 30 ml of THF are dropped to the mixture and after that the reaction is spontaneously left to rise to room temperature and maintained under stirring for 67 hours. The reaction mixture is filtered and the organic phase is concentrated under reduced pressure. The crude product is recrystallized with isopropanol and the precipitated solid is separated by filtering off the solution and dried under vacuum. Carbonic acid 1,3-dioxo-1,3-dihydro-isoindol-2-yl ester methyl ester is obtained as white crystals.

Melting point: 129-135° C.

### EXAMPLE A

### Film Manufacture

Films 1 to 3 are produced as follows: In a turbo mixer (Caccia®, Labo 10) 10%, relative to the weight of the linear low density polyethylene (LLDPE), of each further additive as indicated in Table 1 is mixed with LLDPE [Dowlex NG 5056-G® which contains 0.10% by weight of tris[2,4-di-t-butylphenyl]phosphite and 0.032% by weight of octadecyl-3-(3,5-di-tert-butyl-4-hydroxyphenyl)propionate, and has a melt index of 1.1 g/10 min. (at 190° C. and 2.16 Kg)]. The mixture is extruded at a maximum temperature of 200° C. using an O.M.C. twin-screw extruder (model ebv 19/25) to granules, which are subsequently diluted with the same LLDPE in order to obtain the final composition. This composition is converted to a film 12 μm thick, using a blow-extruder (Dolci®) working at a maximum temperature of 210° C.

Film 4 is produced as follows: In a turbo mixer (Caccia®, Labo 10) 5%, relative to the weight of LLDPE, of each further additive as indicated in Table 1 is mixed with LLDPE [Dowlex NG 5056-G® with the specifications indicated above]. The mixture is extruded at a maximum temperature of 200° C. using an O.M.C. twin-screw extruder (model ebv 19/25) to granules, which are subsequently diluted with the same LLDPE in order to obtain the final composition. This composition is converted to a film 12 μm thick, using a blow-extruder (Dolci®) working at a maximum temperature of 210° C.

Film 5 is produced as follows: In the mixer described above, the further additives indicated in Table 1 are mixed with LLDPE [Dowlex NG 5056-G® with the specifications indicated above] at the final loading. The mixture is extruded at a maximum temperature of 200° C. using a COMAC twin-screw extruder to granules, which are subsequently converted to a film 12 μm thick, using the blow-extruder (Dolci®) working at a maximum temperature of 210° C.

Film 6 is produced as follows: The LLDPE composition, which contains Dowlex NG 5056-G® with the specifications indicated above and the further additives as indicated in Table 1, is obtained as described above and converted to a film 50 μm thick, using the blow-extruder (Formac®) working at a maximum temperature of 210° C.

Films 7 and 8 are produced as follows: In the turbo mixer described above, the further additives indicated in Table 1 are mixed with LLDPE [Dowlex NG 5056-G® with the specifications indicated above] at the final loading. The mixture is extruded at a maximum temperature of 200° C. using an O.M.C. twin-screw extruder to granules, which are subsequently converted to a film 50 μm thick, using the blow-extruder (Formac®) working at a maximum temperature of 210° C.

TABLE 1
Final composition of the LLDPE films.

| Film | Further Additives |
|---|---|
| Film 1 | None |
| Film 2 | 0.14% of Cobalt stearate |
| Film 3 | 0.14% of Cobalt stearate + 0.4% N-(stearoyloxy)phthalimide |
| Film 4 | 0.14% of Manganese Stearate |
| Film 5 | 0.14% of Manganese Stearate + 0.4% N- |
| | octadecyloxyyphthalimide |
| Film 6 | None |
| Film 7 | 0.4% N-trityloxyphthalimide |
| Film 8 | 0.4% N-p-toluene-4-sulfonyloxyphthalimide |

(“%” means “% by weight” relative to the LLDPE)

### Exposure:

1) The obtained film samples are then exposed in an ATLAS Weatherometer® (model Ci65A) equipped with a 6500W Xenon lamp (continuous light cycle, black panel temperature=63° C.).

2) Films are also exposed in a static oven (Heraeus®, model 6120 UT) running at 50° C.

### Evaluation Parameters:

1) Carbonyl increment (CO): Evaluation of the carbonyl band increment (1710 cm−1) in function of the exposure time is monitored with a FT-IR Perkin-Elmer® Spectrum One.

2) Time to cracking: Visual failure of film samples is assessed according to time to the first evidence of surface cracking.

### Results:

Tables 2 to 6 illustrate the results of carbonyl increment and show the time to cracking.

TABLE 2
Carbonyl increment (high values are desired) in WOM
exposure (in hours) of 12 microns LLDPE films.

| Hours | Film 1 | Film 2 | Film 3 |
|---|---|---|---|
| 0 | 0.000 | 0.000 | 0.000 |
| 280 | 0.014 | 0.034 | 0.069 |
| 487 | 0.049 | 0.116 | 0.144 |

TABLE 3
Time to cracking (low values are desired) in WOM
exposure (in hours) of 12 microns LLDPE films.

| | Film 1 | Film 2 | Film 3 |
|---|---|---|---|
| Hours to cracking | 818 | 752 | 487 |

TABLE 4
Carbonyl increment (high values are desired) in oven 50°
C. exposure (in hours) of 12 microns LLDPE films

| Hours | Film 1 | Film 2 | Film 3 |
|---|---|---|---|
| 0 | 0.000 | 0.000 | 0.000 |
| 330 | 0.003 | 0.085 | 0.314 |
| 671 | 0.027 | 0.365 | 0.605 |
| 955 | 0.033 | 0.554 | — |
| 1458 | 0.036 | — | — |
| 2123 | 0.036 | — | — |
| 2888 | 0.049 | — | — |
| 3797 | 0.049 | — | — |
| 4864 | 0.049 | — | — |

TABLE 5
Time to cracking (low values are desired) in oven 50°
C. exposure (in hours) of 12 microns LLDPE films

| | Film 1 | Film 2 | Film 3 |
|---|---|---|---|
| Hours to cracking | >4864 | 955 | 671 |

From the results shown in the Tables 2-5, it can be clearly seen that the addition of a N-hydroxyphthalimide derivative improves the prodegradant performance of transition metals.

TABLE 6
Carbonyl increment (high values are desired) in oven 50°
C. exposure (in hours) of 12 microns LLDPE films

| Hours | Film 4 | Film 5 |
|---|---|---|
| 0 | 0.000 | 0.000 |
| 264 | 0.001 | 0.001 |
| 641 | 0.032 | 0.066 |
| 954 | 0.138 | 0.182 |
| 1292 | 0.180 | 0.270 |
| 1769 | 0.284 | 0.378 |
| 2126 | 0.334 | 0.454 |

In Table 6 it is shown that the addition of a N-hydroxyphthalimide derivative enhances the prodegradant effect of a transition metal.

TABLE 7
Carbonyl increment (high values are desired) in
WOM exposure (in hours) of 50 microns LLDPE films

| Hours | Film 6 | Film 7 | Film 8 |
|---|---|---|---|
| 232 | 0.016 | 0.047 | 0.088 |
| 441 | 0.074 | 0.157 | 0.228 |
| 616 | 0.193 | 0.312 | 0.363 |
| 808 | 0.290 | 0.440 | 0.520 |
| 969 | 0.460 | — | — |
| 1109 | 0.556 | — | — |

TABLE 8
Time to cracking (low values are desired) in WOM
exposure (in hours) of 50 microns LLDPE films

| | Film 6 | Film 7 | Film 8 |
|---|---|---|---|
| Hours to cracking | 1109 | 914 | 808 |

The results shown in the Tables 7 and 8 clearly indicate an improvement of the photodegradation with respect to the non-additivated (blank) film (Film 6).

1. A polymer article having accelerated degradability triggered by light and/or heat and/or humidity and made of a composition containing
(A) a natural and/or a synthetic polymer and
(B) a degradation accelerator of the formula (I) 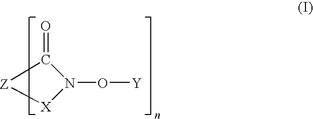
wherein
n is 1, 2 or 4;
X is >C═O, >S(O)₂ or >C(X₁)(X₂);
X₁ and X₂ independently of one another are hydrogen, C₁-C₂₀alkyl, C₃-C₁₂cycloalkyl unsubstituted or substituted by 1, 2 or 3 C₁-C₄alkyl; or phenyl unsubstituted or substituted by 1, 2 or 3 C₁-C₄alkyl;
Y is C₁-C₃₀alkyl, C₂-C₃₀alkenyl, C₃-C₁₂cycloalkyl unsubstituted or substituted by 1, 2 or 3 C₁-C₄alkyl; C₅-C₁₂cycloalkenyl unsubstituted or substituted by 1, 2 or 3 C₁-C₄alkyl; a bicyclic or tricyclic hydrocarbyl having 6 to 10 carbon atoms, C₇-C₉phenylalkyl unsubstituted or substituted on the phenyl by 1, 2 or 3 C₁-C₄alkyl; diphenylmethyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, C₁-C₃₀sulfonyl, —Si(Y₁)₃ or —Si(OY₂)₃;
Y₀, Y₁ and Y₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
and
Z is an organic radical;
with the provisos that
(1) when Y is C₁-C₃₀alkyl, C₂-C₃₀alkenyl or C₁-C₃₀sulfonyl, component (A) is a polyolefin homo- or copolymer or a blend of a polyolefin homo- or copolymer with another synthetic polymer; and
(2) when n is 2 or 4 and, at the same time, component (A) is a polyolefin homo- or copolymer or a blend of a polyolefin homo- or copolymer with another synthetic polymer, Y is additionally hydrogen.

2. A polymer article according to claim 1, wherein Y is different from hydrogen.

3. A polymer article according to claim 1, wherein the composition additionally contains (C) an inorganic or organic salt of a transition metal.

4. A polymer article according to claim 1, wherein the composition additionally contains one or more of components
(D-I) a filler or reinforcing agent,
(D-II) a pigment,
(D-III) a light stabilizer,
(D-IV) a processing additive,
(D-V) an antioxidant,
(D-VI) an inorganic or organic salt of Ca, Mg, Zn or Al, or an oxide of Ca, Mg, Zn or Al,
(D-VII) a terpene derivative, an anthraquinone derivative and/or a benzophenone derivative or
(D-VIII) an inorganic oxidant.

5. A polymer article according to claim 1, which is an agricultural article.

6. A polymer article according to claim 5, wherein the agricultural article is selected from the group consisting of mulch films, small tunnel films, row covers, banana bags, direct covers, nonwoven, twines and pots.

7. A polymer article as defined in claim 1, which is a monolayer or three-layer mulch film having a thickness of 5 to 100 microns; the provisos of claim 1 being not applied.

8. A polymer article as defined in claim 1, which is a monolayer or three-layer mulch film having a thickness of 5 to 100 microns and being partly buried with soil; the provisos of claim 1 being not applied.

9. A polymer article according to claim 1, which is a packaging material is a consumer products material.

10. A polymer article according to claim 9, wherein the packaging material is for food, beverage or cosmetics.

11. A polymer article according to claim 1, which is a hygienic or medical article.

12. A polymer article according to claim 1, which is selected from the group consisting of films, fibers, profiles, bottles, tanks, containers, sheets, bags, styrofoam cups, plates, blister packages, boxes, package wrappings and tapes.

13. A polymer article according to claim 1 which is shaped by injection-molding, blow-molding, compression-molding, roto-molding, slush-molding, extrusion, film casting, film blowing, calendering, thermoforming, spinning or rotational casting.

14. A polymer article according to claim 1, wherein
Z is an organic radical containing one or more aromatic groups.

15. A polymer article according to claim 1, wherein
when n is 1, Z is a group of the formula (I-a), (I-b), (I-c), (I-d), (I-e), (I-f), (I-g), (I-h), (I-i), (I-j), (I-k), (I-l), (I-m) or (I-n), 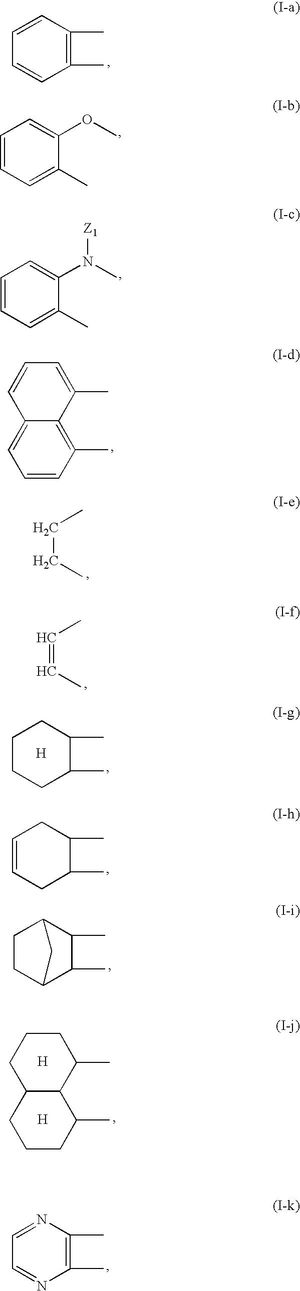 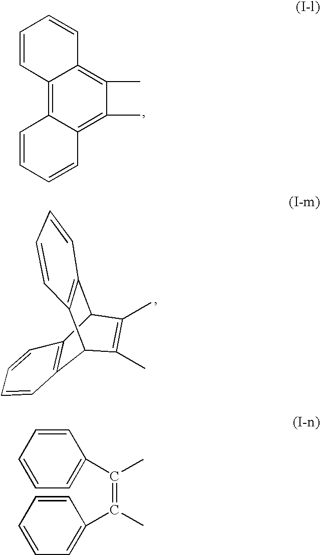
the aromatic rings of the formulae (I-a) to (I-d) and (I-k) to (I-n) and the residues of the formulae (I-e) to (I-j) are optionally substituted by one or more hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl; C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₁₀₀, Z₁₀₁, Z₁₀₂ and Z₁ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
when n is 2, Z is a group of the formula (II-a), (II-b), (II-c) or (II-d), 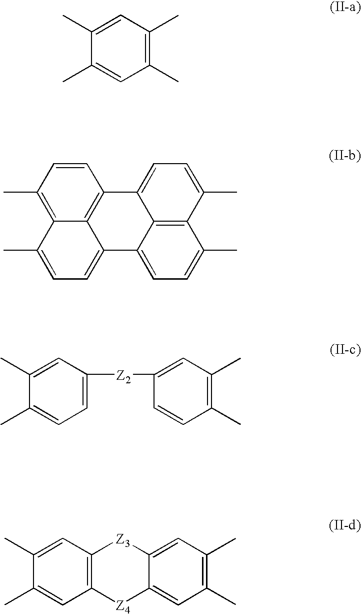
the aromatic rings of the formulae (II-a) to (II-c) are optionally substituted by one or more hydroxy, C₁-C₃₀alkyl, C₁-C₃₀alkyloxy, C₂-C₃₀ alkenyl, C₂-C₃₀alkenyloxy, C₃-C₁₂cycloalkyl unsubstituted or substituted by 1, 2 or 3 C₁-C₄alkyl;
C₃-C₁₂cycloalkyloxy unsubstituted or substituted by 1, 2 or 3 C₁-C₄alkyl; C₆-C₁₈aryl, C₆-C₁₈ aryloxy, C₂-C₃₀carboxylate, C₂-C₃₀carboxamide, C₂-C₃₀acyloxy, C₁-C₃₀acyl, C₁-C₃₀sulfonyl, —S-Z₁₀₀, —S(O)₂(N(Z₁₀₁)₂), —N(Z₁₀₂)₂, —F, —Cl, —Br, —NO₂ or —COOH;
Z₂ is >C═O, —O—, —S—, >N—R₁, >S═O or —S(O)₂—, C₃-C₃₀diacyl, C₃-C₃₀di(acyloxy), C₃-C₄₅dicarboxylate, C₃-C₄₅di(carboxamide), diamine or diamide;
Z₃ and Z independently of one another are >C═O, —O—, —S—, >N—R₂, >S═O or —S(O)₂—;
R₁ and R₂ independently of one another are hydrogen, C₁-C₁₈alkyl, C₃-C₁₈alkenyl, C₃-C₁₂cycloalkyl which is unsubstituted or substituted by 1, 2 or 3 C₁-C₄alkyl; phenyl which is unsubstituted or substituted by 1, 2 or 3 C₁-C₄alkyl; or C₇-C₉phenylalkyl which is unsubstituted or substituted on the phenyl by 1, 2 or 3 C₁-C₄alkyl;
when n is 4, Z is a group of the formula (III-a)

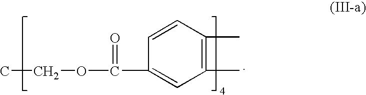

16. A polymer article according to claim 15, wherein Y is hydrogen and
when n is 1, Z is a group of the formula (I-b), (I-c), (I-d), (I-j, (I-k), (I-l), (I-n) or (I-m), and
when n is 2, Z is a group of the formula (II-a), (II-b), (II-c) or (II-d).

17. A polymer article according to claim 15, wherein
when n is 1, Z is a group of the formula (I-a) unsubstituted or substituted by C₂-C₃₀carboxylate or C₂-C₃₀carboxamide; and
when n is 2, Z is a group of the formula (II-a) or (II-c).

18. A polymer article according to claim 15, wherein
when n is 1, Z is a group of the formula (I-a) substituted on the aromatic ring by —COOH, an C₈-C₂₂alkylcarboxylate of the formula 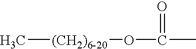
or an C₈-C₂₂alkylcarboxamide of the formula 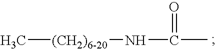
or a group of the formula (I-d); and
when n is 2, Z is a group of the formula (II-c) wherein Z₂ is a dicarboxylate of the formula 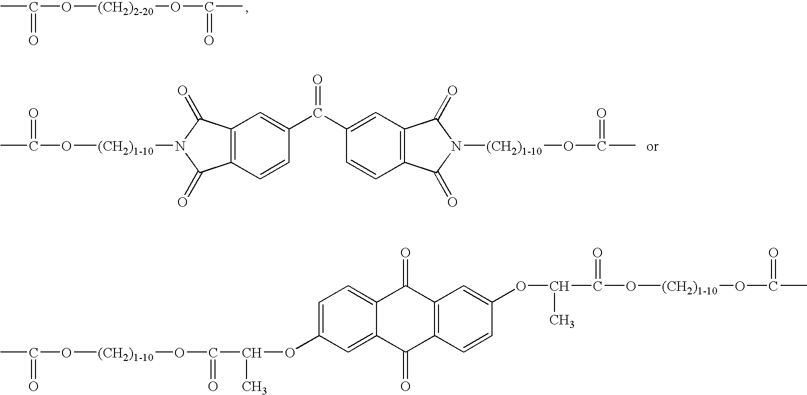
or a di(carboxamide) of the formula

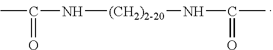

19. A polymer article according to claim 1, wherein Y is C₁-C₃₀alkyl, C₇-C₉phenylalkyl unsubstituted or substituted on the phenyl by 1, 2 or 3 C₁-C₄alkyl; triphenylmethyl unsubstituted or substituted on the phenyl by 1, 2 or 3 C₁-C₄alkyl; C₂-C₃₀acyl, —COOY₀, C₁-C₃₀sulfonyl or —Si(Y₁)₃; and
Y₀ and Y₁ are C₁-C₁₈alkyl or phenyl which is unsubstituted or substituted by 1, 2 or 3 C₁-C₄alkyl.

20. A polymer article according to claim 15, wherein n is 1 or 2, and
when n is 1, Z is a group of the formula (I-a) or (I-d), the aromatic rings of the formula (I-a) or (I-d) are optionally substituted by C₂-C₃₀carboxylate or —COOH;
when n is 2, Z is a group of the formula (II-a) or (II-c), and
Z₂ is >C═O or C₃-C₄₅dicarboxylate.

21. A polymer article according to claim 1, wherein
n is 1 or 2;
Y is C₁-C₃₀alkyl, triphenylmethyl, benzyl, C₂-C₃₀alkanoyl, 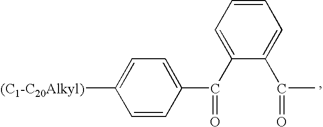
—COOY₀ with Y₀ being C₁-C₁₈alkyl;
tosyl or tert-butyldiphenylsilanyl, and when n is 2, Y is additionally hydrogen;
when n is 1, Z is a group of the formula 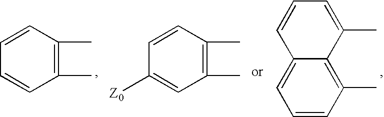
where Z₀ is COOH or —COO—(C₁-C₂₀alkyl); and
when n is 2, Z is a group of the formula

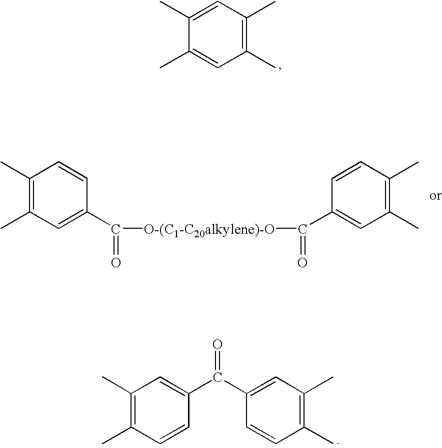

22. A polymer article according to claim 1, wherein component (B) is a compound of the formula

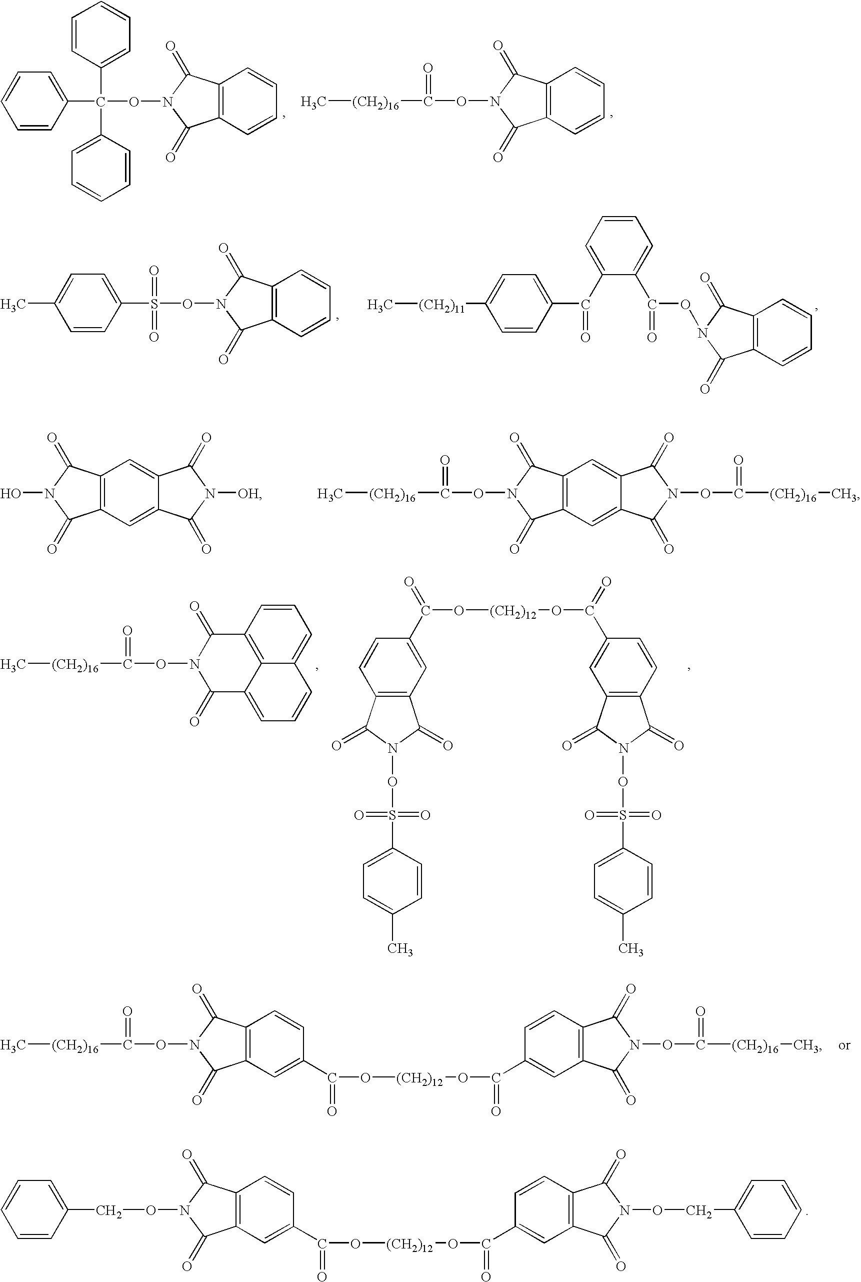

23. A polymer article according to claim 1, wherein
component (A) is a thermoplastic synthetic polymer.

24. A polymer article according to claim 1, wherein
component (A) is a polyolefin homo- or copolymer, a polyester homo- or copolymer, a polyamide homo- or copolymer, blends thereof, a starch modified polyolefin or a starch based polymer composite.

25. A polymer article according to claim 1, wherein
component (A) is polyethylene, polypropylene, a polyethylene copolymer or a polypropylene copolymer.

26-32. (canceled)
